(19) United States
(12) Patent Application Publication
(10) Pub. No.: US 2021/0173485 A1
(43) Pub. Date: Jun. 10, 2021

(54) HAPTIC INTERACTION DEVICE AND CONTROL METHOD THEREFOR

(71) Applicant: KOREA UNIVERSITY OF TECHNOLOGY AND EDUCATION INDUSTRY -UNIVERSITY COOPERATION FOUNDATION, Cheonan-si, Chungcheongnam-do (KR)

(72) Inventors: Jee Hwan RYU, Cheonan-si (KR); Harsimran SINGH, Cheonan-si (KR)

(21) Appl. No.: 16/317,820

(22) PCT Filed: Jul. 4, 2017
(86) PCT No.: PCT/KR2017/007094

§ 371 Date: Jan. 14, 2019

Related U.S. Application Data
(60) Provisional application No. 62/370,725, filed on Aug. 4, 2016.

(30) Foreign Application Priority Data
Jul. 12, 2016 (KR) 10-2016-0088238
Aug. 31, 2016 (KR) 10-2016-0111567
Nov. 24, 2016 (KR) 10-2016-0157634

(51) Int. Cl. G06F 3/01

(52) U.S. Cl. CPC G06F 3/016; G06T 19/006

(57) ABSTRACT

A haptic interaction device include: a setting unit configured such that, when a desired stiffness related to a penetration depth of a haptic interaction point in a virtual environment and a feedback force corresponding to the penetration depth is designated, the setting unit sets a feedback force that is to occur when the haptic interaction point penetrates the virtual environment; a checkup unit checking, when a cycle is ended, the stiffness at the cycle during which the haptic interaction point penetrates the virtual environment along a pressing path and moves along a releasing path in the opposite direction to the direction of penetration according to the feedback force that has been set; and a determination unit determining a feedforward force offset value related to a feedback force at the next cycle adjacent to the cycle based on a result of comparing the checked stiffness and the desired stiffness.

### BACKGROUND OF THE INVENTION

### 1. Field of the Invention

The present disclosure relates to a haptic interaction device and a method for controlling the same.

### 2. Description of the Prior Art

A haptic interaction generates a bidirectional energy flow between a haptic interaction device by which a haptic effect is generated and an operator (user) who drives the haptic interaction device. The haptic effect includes effects that enable the user to feel a tactile sensation, a force, a kinesthesia, and the like. Such generation and flow of energy depend on rendering of a virtual environment (VE).

When a strong contact with a virtual wall that corresponds to a boundary of the VE is rendered, an unstable behavior such as vibration may be observed from the haptic interaction device.

Such a behavior may damage the haptic interaction device, may distract the operator, or may hurt the operator in a worse case.

Therefore, analysis of stability in haptic interaction in this regard is an important issue that is not to be neglected.

Accordingly, there is various ongoing research for providing a stable haptic interaction in a wide impedance range, but the stiffness is sacrificed, in order to secure stability, by approaches in most research.

As such, there is a need to provide a new approach capable of implementing a high-stiffness haptic interaction while securing stability.

### SUMMARY OF THE INVENTION

An embodiment of the present disclosure proposes a method and a system for providing a haptic augmented reality through a haptic interaction device. Specifically, an embodiment of the present disclosure proposes a method and a system for providing a stable high-stiffness haptic interaction, as an approach for widening the range of displayed stiffness of impedance-type haptic interfaces.

An embodiment of the present disclosure proposes a method for improving the rate-hardness related to recognition of a contact in a virtual environment by a user while providing a high stiffness, provided that stability is guaranteed in connection with a haptic interaction based on a virtual environment.

An embodiment of the present disclosure proposes a method for implementing a haptic interaction with a virtual environment having a high stiffness, provided that stability is guaranteed in connection with a haptic interaction based on a virtual environment.

In accordance with an aspect of the present disclosure, there is provided a method for providing a haptic augmented reality through a haptic device, the method including: setting a desired stiffness of a virtual environment by a controller of the haptic device, a desired feedback force being defined according to a desired inclination of a penetration distance versus a feedback force such that the same occurs so as to correspond to a penetration distance into the virtual environment at the desired stiffness, and the penetration distance being a distance by which one end of the haptic device enters the virtual environment; generating a feedback force according to a stiffness lower than the desired stiffness by a driver of the haptic device while repeating a cycle during which one end of the haptic device moves along a pressing path and a releasing path, the penetration distance into the virtual environment increasing along the pressing path and decreasing in the releasing path; and conducting a control by the controller of the haptic device such that the feedback force following the penetration distance at each cycle increases compared with the feedback force of the previous cycle, the penetration distance of one end of the haptic device converges at a predetermined location as the cycle is repeated, and the inclination of the penetration distance of the converging location versus the feedback force occurring at the converging location arrives the desired inclination.

The feedback force occurring in the pressing path is defined by equation a below:

$$f ( x ) = \{ \begin{matrix}{K}_{s} x + {F}_{r} , & for x \geq 0 \\ 0 , & for x < 0\end{matrix} \qquad \text{<} equation a \text{>}$$

In equation a above, Kₛ refers to the first inclination of the penetration distance versus the feedback force in the pressing path; x refers to the penetration distance; and Fᵣ is zero at the first cycle, and is then the value of the feedback force at the last location in connection with the movement along the releasing path of the previous cycle.

In addition, the feedback force occurring in the releasing path is defined by equation b below:

$$f ( x ) = \{ \begin{matrix}μ x + {F}_{f} , & for x \geq 0 \\ 0 , & for x < 0\end{matrix} \qquad \text{<} equation b \text{>}$$

In equation b above, u refers to the second inclination of the penetration distance versus the feedback force in the releasing path, x refers to the penetration distance, and F_{f} is a value larger than zero, which has been set to occur when the penetration distance is zero, and increases in proportion to the cycle number.

The first inclination or the second inclination may be a function of the penetration distance.

In accordance with an aspect of the present disclosure, there is provided a system for providing a haptic augmented reality through a haptic device, the system including: a controller configured to set a desired stiffness of a virtual environment and to determine a feedback force according to a stiffness lower than the desired stiffness, the feedback force being generated while repeating a cycle during which one end of the haptic device moves along a pressing path and a releasing path, the penetration distance into the virtual environment increasing along the pressing path and decreasing in the releasing path, the penetration distance being a distance by which one end of the haptic device enters the virtual environment; and a driver configured to drive a feedback force to the haptic device by the force determined by the controller, wherein a desired feedback force is defined according to a desired inclination of a penetration distance versus a feedback force such that the same occurs so as to correspond to a penetration distance into the virtual environment at the desired stiffness; a feedback force that occurs so as to correspond to the penetration distance into the virtual environment according to a stiffness lower than the desired stiffness occurs according to the inclination of the penetration distance versus the feedback force; the inclination is smaller than the desired inclination; the penetration distance of one end of the haptic device converges at a predetermined location as the cycle is repeated; and the inclination of the penetration distance of the converging location versus the feedback force occurring at the converging location arrives the desired inclination.

The feedback force occurring in the pressing path is defined by equation a below:

$$J ( x ) = \{ \begin{matrix}{K}_{s} x + {F}_{r} , & for x \geq 0 \\ 0 , & for x < 0\end{matrix} \qquad \text{<} equation a \text{>}$$

In equation a above, Kₛ refers to the first inclination of the penetration distance versus the feedback force in the pressing path; x refers to the penetration distance; and Fᵣ is zero at the first cycle, and is then the value of the feedback force at the last location in connection with the movement along the releasing path of the previous cycle.

In addition, the feedback force occurring in the releasing path is defined by equation b below:

$$J ( x ) = \{ \begin{matrix}μ x + {F}_{f} , & for x \geq 0 \\ 0 , & for x < 0\end{matrix} \qquad \text{<} equation b \text{>}$$

In equation b above, u refers to the second inclination of the penetration distance versus the feedback force in the releasing path, x refers to the penetration distance, and F_{f} is a value larger than zero, which has been set to occur when the penetration distance is zero, and increases in proportion to the cycle number.

In accordance with an aspect of the present disclosure, there is provided a computer-readable storage medium in which a computer program is recorded, wherein the computer program, when executed by a processor, causes a computer to execute the above method.

In accordance with an aspect of the present disclosure, there is provided a haptic interaction device including: a setting unit configured such that, when a desired stiffness related to a penetration depth of a haptic interaction point in a virtual environment and a feedback force corresponding to the penetration depth is designated, the setting unit sets a feedback force that is to occur when the haptic interaction point penetrates the virtual environment; a checkup unit configured to check, when a cycle is ended, the stiffness at the cycle during which the haptic interaction point penetrates the virtual environment along a pressing path and moves along a releasing path in the opposite direction to the direction of penetration according to the feedback force that has been set; and a determination unit configured to determine a feedforward force offset value related to a feedback force at the next cycle adjacent to the cycle on the basis of a result of comparing the stiffness checked at the cycle and the desired stiffness.

More specifically, the feedforward force offset value is determined to be a zero value when the cycle is the initial cycle during which the haptic interaction point penetrates the virtual environment.

More specifically, the feedforward force offset value is determined such that, when the stiffness checked at the cycle is smaller than the desired stiffness by at least a threshold value, the offset value at the adjacent next cycle is determined to larger than the offset value at the cycle, when the stiffness checked at the cycle is larger than the desired stiffness by at least the threshold value, the offset value at the adjacent next cycle is determined to smaller than the offset value at the cycle, and when the difference between the stiffness checked at the cycle and the desired stiffness is within the threshold value, the feedforward force offset value is determined to toggle with reference to the offset value at the cycle.

More specifically, the setting unit is configured to set a feedback force, which occurs according to the penetration distance of the haptic interaction point into the virtual environment, to be smaller than a feedback force that is to be generated by the desired stiffness.

In accordance with another aspect of the present disclosure, there is provided a haptic interaction method including the steps of: setting, when a desired stiffness related to a penetration depth of a haptic interaction point in a virtual environment and a feedback force corresponding to the penetration depth is designated, a feedback force that is to occur when the haptic interaction point penetrates the virtual environment; checking, when a cycle is ended, the stiffness at the cycle during which the haptic interaction point penetrates the virtual environment along a pressing path and moves along a releasing path in the opposite direction to the direction of penetration according to the feedback force that has been set; and determining a feedforward force offset value related to a feedback force at the next cycle adjacent to the cycle on the basis of a result of comparing the stiffness checked at the cycle and the desired stiffness.

More specifically, the feedforward force offset value is determined to be a zero value when the cycle is the initial cycle during which the haptic interaction point penetrates the virtual environment.

More specifically, the feedforward force offset value is determined such that, when the stiffness checked at the cycle is smaller than the desired stiffness by at least a threshold value, the offset value at the adjacent next cycle is determined to larger than the offset value at the cycle, when the stiffness checked at the cycle is larger than the desired stiffness by at least the threshold value, the offset value at the adjacent next cycle is determined to smaller than the offset value at the cycle, and when the difference between the stiffness checked at the cycle and the desired stiffness is within the threshold value, the feedforward force offset value is determined to toggle with reference to the offset value at the cycle.

More specifically, in the setting step, a feedback force that occurs according to the penetration distance of the haptic interaction point into the virtual environment is set to be smaller than a feedback force that is to be generated by the desired stiffness.

In accordance with another aspect of the present disclosure, there is provided a computer program implemented to execute each step of the haptic interaction method and recorded in a computer-readable recording medium.

In accordance with another aspect of the present disclosure, there is provided a computer-readable recording medium including an instruction for executing each step of the haptic interaction method.

In accordance with another aspect of the present disclosure, there is provided a haptic interaction device for improving rate-hardness, including: a setting unit configured to make settings such that, when a desired stiffness related to a penetration depth of a haptic interaction point in a virtual environment and a feedback force corresponding to the penetration depth is determined, a feedback force is generated according to the desired stiffness in a pressing path of the initial cycle during which the haptic interaction point initially penetrates the virtual environment, and a feedback force is generated according to a stiffness lower than the desired stiffness in a releasing path of the initial cycle and in a pressing path and a releasing path of the following cycle; a checkup unit configured to check, when a cycle is ended, stiffness at the cycle during which the haptic interaction point penetrates the virtual environment along a pressing path and moves along a releasing in the opposite direction to the penetration direction; and a determination unit configured to determine a feedforward force offset value related to a feedback force at the next cycle adjacent to the cycle on the basis of a result of comparing the stiffness checked at the cycle and the desired stiffness.

More specifically, the feedforward force offset value is determined such that, when the stiffness checked at the cycle is smaller than the desired stiffness by at least a threshold value, the offset value at the adjacent next cycle is determined to larger than the offset value at the cycle, when the stiffness checked at the cycle is larger than the desired stiffness by at least the threshold value, the offset value at the adjacent next cycle is determined to smaller than the offset value at the cycle, and when the difference between the stiffness checked at the cycle and the desired stiffness is within the threshold value, the feedforward force offset value is determined to toggle with reference to the offset value at the cycle.

More specifically, when the feedback force at the initial cycle is set according to the desired stiffness, a rate-hardness related to recognition of a contact in the virtual environment by a user is improved compared with a rate-hardness of a case in which the feedback force is set according to a stiffness lower than the desired stiffness.

More specifically, the releasing path is set such that a feedback force exists even when the haptic interaction point has escaped from a virtual wall which is a boundary of the virtual environment, and the feedback force outside the virtual environment is set to be continuous on a line of extension of the feedback force inside the virtual environment.

In accordance with another aspect of the present disclosure, there is provided a haptic interaction method for improving rate-hardness, including: making settings such that, when a desired stiffness related to a penetration depth of a haptic interaction point in a virtual environment and a feedback force corresponding to the penetration depth is determined, a feedback force is generated according to the desired stiffness in a pressing path of the initial cycle during which the haptic interaction point initially penetrates the virtual environment, and a feedback force is generated according to a stiffness lower than the desired stiffness in a releasing path of the initial cycle and in a pressing path and a releasing path of the following cycle; checking, when a cycle is ended, stiffness at the cycle during which the haptic interaction point penetrates the virtual environment along a pressing path and moves along a releasing in the opposite direction to the penetration direction; and determining a feedforward force offset value related to a feedback force at the next cycle adjacent to the cycle on the basis of a result of comparing the stiffness checked at the cycle and the desired stiffness.

More specifically, the feedforward force offset value is determined such that, when the stiffness checked at the cycle is smaller than the desired stiffness by at least a threshold value, the offset value at the adjacent next cycle is determined to larger than the offset value at the cycle, when the stiffness checked at the cycle is larger than the desired stiffness by at least the threshold value, the offset value at the adjacent next cycle is determined to smaller than the offset value at the cycle, and when the difference between the stiffness checked at the cycle and the desired stiffness is within the threshold value, the feedforward force offset value is determined to toggle with reference to the offset value at the cycle.

More specifically, when the feedback force at the initial cycle is set according to the desired stiffness, a rate-hardness related to recognition of a contact in the virtual environment by a user is improved compared with a rate-hardness of a case in which the feedback force is set according to a stiffness lower than the desired stiffness.

More specifically, the releasing path is set such that a feedback force exists even when the haptic interaction point has escaped from a virtual wall which is a boundary of the virtual environment, and the feedback force outside the virtual environment is set to be continuous on a line of extension of the feedback force inside the virtual environment.

In accordance with another aspect of the present disclosure, there is provided a computer program implemented so as to execute respective steps of the haptic interaction method for improving rate-hardness and recorded in a computer-readable recording medium.

In accordance with another aspect of the present disclosure, there is provided a computer-readable recording medium including an instruction for executing respective steps of the haptic interaction method for improving rate-hardness.

The haptic interaction device and the method for operating the same according to the present disclosure are advantageous in that a successive force augment (SFA) approach that uses a feedforward force offset value is adopted such that a high-stiffness haptic interaction with a virtual environment can be implemented, provided that stability of the interaction is guaranteed.

In addition, it is possible to improve the rate-hardness related to recognition of a contact in a virtual environment by a user while providing a high stiffness, provided that stability of the interaction is guaranteed.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a position versus force graph illustrating the concept of an SSI approach according to the present disclosure;

FIG. 2 illustrates a control structure related to the SSI approach proposed according to the present disclosure;

FIG. 3 schematically illustrates calculation of a local inclination u according to the present disclosure;

FIG. 4 and FIG. 5 illustrate an unstable haptic interaction regarding a virtual wall having a stiffness of 5 N/mm;

FIG. 6 to FIG. 9 illustrate results obtained by implementing the SSI approach according to the present disclosure under the same experiment condition as that of FIG. 4;

FIG. 10 to FIG. 12 illustrate a comparison between the SSI approach according to the present disclosure and a force bounding approach (FBA);

FIG. 13 illustrates a haptic interaction system according to another embodiment of the present disclosure;

FIG. 14 illustrates a schematic configuration of a haptic interaction device according to an embodiment of the present disclosure;

FIG. 15 illustrates a feedforward offset according to an embodiment of the present disclosure;

FIG. 16 and FIG. 17 illustrate an SFA approach according to an embodiment of the present disclosure;

FIG. 18 illustrates a flow of operations by a haptic interaction device according to an embodiment of the present disclosure;

FIG. 19 and FIG. 20 illustrate an unstable haptic interaction with a virtual wall having a stiffness of 5 N/mm in connection with a haptic interaction device;

FIG. 21 to FIG. 24 illustrate a stable haptic interaction with a virtual wall having a stiffness of 5 N/mm in connection with a haptic interaction device;

FIG. 25 to FIG. 27 illustrate a comparison between a haptic interaction in the SFA approach according to an embodiment of the present disclosure and a force bounding approach (FBA);

FIG. 28 and FIG. 29 illustrate an extended SFA approach according to an embodiment of the present disclosure;

FIG. 30 illustrates a flow of operations by a haptic interaction device according to an embodiment of the present disclosure;

FIG. 31 and FIG. 32 illustrate a stable haptic interaction with a virtual wall having a stiffness of 1 N/mm in connection with a haptic interaction device;

FIG. 33 and FIG. 34 illustrate an unstable haptic interaction with a virtual wall having a stiffness of 5 N/mm in connection with a haptic interaction device;

FIG. 35 to FIG. 38 illustrate a case in which the extended SFA approach is applied to a virtual wall having a stiffness of 3 N/mm in connection with a haptic interaction device according to an embodiment of the present disclosure;

FIG. 39 to FIG. 42 illustrate a case in which the extended SFA approach is applied to a virtual wall having a stiffness of 5 N/mm in connection with a haptic interaction device according to an embodiment of the present disclosure;

FIG. 43 to FIG. 45 illustrate a comparison between a rate-hardness when the SFA approach is applied and a rate-hardness when the extended SFA approach is applied in connection with a haptic interaction device according to an embodiment of the present disclosure; and

FIG. 46 to FIG. 48 illustrate a comparison between a displayed stiffness when the SFA approach is applied and a displayed stiffness when the extended SFA approach is applied in connection with a haptic interaction device according to an embodiment of the present disclosure.

### DETAILED DESCRIPTION OF THE EXEMPLARY EMBODIMENTS

Hereinafter, “a method and a system for providing a haptic augmented reality through a haptic device” according to the present disclosure will be described in detail with reference to the accompanying drawings. Descriptions of embodiments are intended to enable a person skilled in the art to easily understand the technical idea of the present disclosure without limiting the present disclosure. In addition, details are schematically illustrated in the drawings in order to easily describe embodiments of the present disclosure, and may differ from actual modes implementation.

Meanwhile, each constituent unit described herein is only an example for implementing the present disclosure. Accordingly, a different constituent unit may be used in another implementation of the present disclosure as long as the same does not deviate from the idea and scope of the present disclosure.

Throughout the entire specification, a description that a part is “connected” to another part includes not only a case in which the same is “directly connected”, but also a case in which the same is “indirectly connected” with a different element interposed therebetween. The expression that constituent elements are “included” is an open-type expression simply meaning that the corresponding constituent elements exist, and is not to be understood as excluding additional constituent elements.

Moreover, expressions such as “first” and “second” are simply used to distinguishing a plurality of constituent elements, and do not limit the order among the constituent elements or other characteristics thereof.

In addition, although present disclosures are described in connection with various embodiments, the present disclosures are not intended to be limited to such embodiments. The present disclosures rather include various alternatives, modifications, and equivalents as will be understood by a person skilled in the art.

1. Summary

Two specific aspects that are responsible for system instability in the prior art are discretization and zero-order sample-and-hold. When a controller designed for a continuous domain is implemented in a discrete domain, the performance thereof is sure to drop. An actual interaction and a virtual-word interaction are completely different, and the latter is an approximation model of the actual world. Such an approximation depends on the sampling rate, and the larger the sampling rate, the better the approximation. However, very small errors may accumulate and may actually have a significant influence. Haptic interaction may diverge as a result of instability and bounding period vibration, and the instability and bounding period vibration both result from non-passivity. The human tactile sense is very sensitive to vibrations in the range of 100 Hz to 1 kHz, and even small bounding periods may distort transparency or feelings regarding the virtual environment.

Much research has been conducted to accomplish a stable haptic interaction, and most research is based on passivity restriction. A passivity standard has several valuable attributes. For example, the passivity standard uses only input/output information independently of system parameters, the passivity standard itself is a sufficient condition regarding stability, and the same is normally applicable to both linear and non-linear systems. Derived from a passivity theory, several different approaches have been proposed for a stable haptic interaction, such as a time-domain passivity approach, an energy bounding algorithm, a force bounding algorithm, and a wave variable approach. Although such approaches have been proposed to guarantee stability of haptic interfaces, most approaches cover only a limited range of stiffness, or sacrifice the actually displayed stiffness as an expense for stability.

In the present disclosure, an approach will be described which can guarantee stability while further expanding the accomplishable stiffness range. The present disclosure proposes, as a method for providing a high-stiffness haptic interaction while maintaining stability, a novel method that continuously increases the stiffness while increasing the number of interaction cycles. In this regard, one cycle may be configured as a movement of a probe of a haptic device along a single pressing path and a single releasing path. According to a method of the present disclosure, the stiffness is modulated successively from a low value to a high value while maintaining stability such that the desired stiffness can be reached closely. Such a successive increase of stiffness is made possible because the method proposed by the present disclosure guarantees convergence of the penetration distance and increases the feedback force at each continuous interaction cycle. The haptic interaction is started by displaying a small stiffness value, and the stiffness value then increases through several cycles such that the same approaches the desired value. Such an increase is accomplished by gradually increasing the feedback force at each continuous cycle. The main advantage of the approach proposed herein, compared with conventional approaches, is that a larger actually-displayed stiffness is made possible compared with other approaches such as the time-domain passivity approach, the force bounding approach, and the energy bounding approach.

In the present disclosure, the normal concept of a haptic interaction in low-stiffness and high-stiffness virtual environments will be described first, a successive stiffness increment (SSI) according to the present disclosure will be described, and functions used to calculate forces in a pressing path and in a releasing path will be described in detail. In the closing description of the present disclosure, furthermore, performance of approaches proposed in the present disclosure will be evaluated through experiments based on ToM Premium 1.5, and the actually displayed stiffness thereof will be compared with that of other approaches.

2. Haptic Interaction in Low-Stiffness and High-Stiffness Virtual Environments

Energy generated by an interaction in a high-stiffness virtual environment is larger than energy that can be released by friction unique to a haptic device. Therefore, energy remaining after the first cycle operates as initially stored energy with regard to the second cycle. Accordingly, the haptic probe comes to have more energy in connection with penetrating a virtual environment having the same stiffness gain. Consequently, the system vibrates on a larger scale, and the position response diverges over time.

In contrast, when generated energy is smaller than energy released by physical damping of the system, the interaction maintains the stability. After the haptic probe penetrates the virtual environment, the haptic probe moves forward/backward during several cycles and converges to a point where the force of the human operator becomes almost identical to the force from the virtual environment. Due to sampling and zero-order hold, there may be small vibration in the periphery of the converging point even after the convergence.

3. Successive Stiffness Increment (SSI) Approach

In order to increase the displayed stiffness while maintaining stability, the present disclosure proposes an approach configured such that the stiffness starts from a small value and increases gradually during a continuous cycle. In such an approach, the stiffness starts from a low value and is successively modulated such that energy generated at each cycle can be small, and the same can accordingly be referred to as a successive stiffness increment (SSI) approach. Moreover, the proposed SSI approach guarantees convergence of the penetration distance and increases the feedback force at each continuous interaction cycle; accordingly, energy generated at each cycle finally converges, over several cycles, to a small value that can be released by physical damping unique to the haptic display.

3.1 Overview of SSI Approach

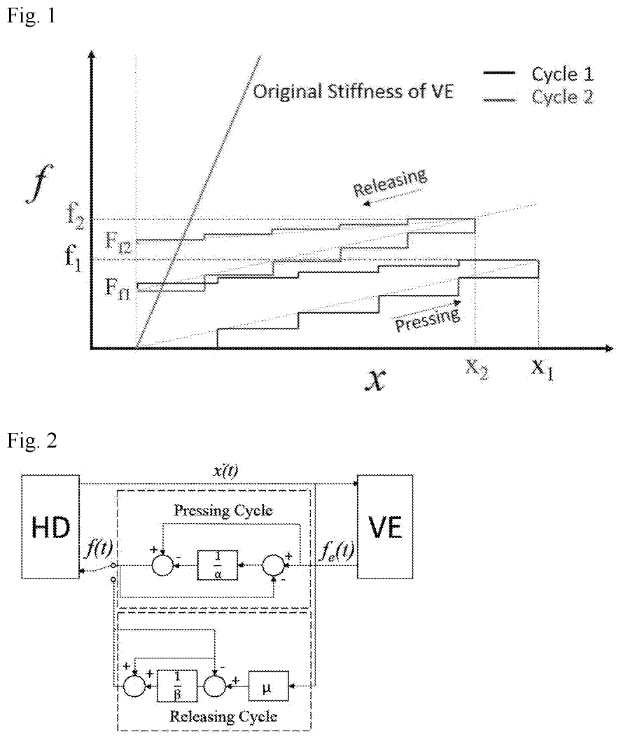

Hereinafter, for the purpose of intuitive understanding, the SSI approach will be described conceptually with regard to each cycle by using a position versus force graph. FIG. 1 is a position versus force graph illustrating the concept of the SSI approach according to the present disclosure. FIG. 1 illustrates the original stiffness of the VE that is desired, and such a stiffness may be defined according to the inclination of the penetration distance versus the feedback force regarding the desired feedback force such that the same occurs so as to correspond to the penetration distance into the VE. That is, as illustrated in FIG. 1, the larger the inclination of the penetration distance versus the feedback force, the larger the stiffness of the VE, and the smaller the inclination, the larger the stiffness of the VE. In this regard, the inclination of the penetration distance versus the feedback force that the stiffness of the desired VE has may be referred to as a desired inclination. The approach proposed by the present disclosure may be divided into two sections, that is, a pressing path and a releasing path. FIG. 1 illustrates only two exemplary cycles, and the correspondence of the penetration distance versus the feedback force in the pressing path and releasing path is indicated at each cycle. The force in the pressing path is a function of a stiffness smaller than the originally desired VE stiffness, and the stiffness in this case is selected such that generated energy is smaller than the energy released by damping unique to the haptic device. As illustrated in FIG. 1, the feedback force that occurs so as to correspond to the penetration distance into the VE in the pressing path occurs according to the path inclination of the penetration distance versus the feedback force, and the path inclination has a value smaller than the desired inclination. Considering the fact that the interaction of the haptic probe with the VE may be modeled as a simple virtual spring, the force in the pressing path may be set as in equation 1 below:

$$f ( n ) = \{ \begin{matrix}{K}_{s} x ( n ) + {F}_{r} , & for x ( n ) \geq 0 \\ 0 , & for x ( n ) < 0\end{matrix} \qquad [ equation 1 ]$$

wherein, Kₛ refers to a selected small stiffness, x(n) refers to the penetration distance, and Fᵣ refers to the value of the final force of the releasing path of the previous cycle. It is to be noted that the pressing path starts at the point where the releasing path of the previous cycle has ended. At the first cycle, Fᵣ may be zero. As used herein, the penetration distance x(n) refers to the distance by which one end of the haptic device has entered the VE, and n refers to a point where the f value corresponding to the penetration distance forms a step shape. In addition, the pressing path may be a path along which the penetration distance increases, and the releasing path may be a path along which the penetration distance decreases.

The feedback force occurring in the pressing path may also be defined by equation a below:

$$J ( x ) = \{ \begin{matrix}{K}_{s} x + {F}_{r} , & for x \geq 0 \\ 0 , & for x < 0\end{matrix} \qquad \text{<} equation a \text{>}$$

In equation a above, Kₛ refers to the first inclination of the penetration distance versus the feedback force in the pressing path; x refers to the penetration distance; and Fᵣ is zero at the first cycle, and may then be the value of the feedback force at the last location in connection with the movement along the releasing path of the previous cycle.

In addition, the force in the releasing path is not defined according to equation 1. The function regarding the releasing path is selected such that the value of the force has an arbitrary non-zero finite value even when the penetration distance is zero. These are illustrated in FIG. 1 as F_{f1} and F_{f2}, which are finite force values at zero penetration distance after first and second cycles. Therefore, the function regarding the releasing path is expressed as in equation 2:

$$f ( n ) = \{ \begin{matrix}μ x ( n ) + {F}_{f} , & for x ( n ) \geq 0 \\ 0 , & for x ( n ) < 0\end{matrix} \qquad [ equation 2 ]$$

wherein, u refers to the inclination in the releasing path, x(n) refers to the penetration distance, and F_{f} refers to a selected finite force value when the penetration distance is zero. It is clear from equation 1 that the pressing path starts at the point where the releasing path of the previous cycle has ended and, after the first releasing path, F_{f} will become Fᵣ for the second pressing path. In addition, following equation b may be used instead of equation 2 given above:

$$J ( x ) = \{ \begin{matrix}μ x + {F}_{f} , & for x \geq 0 \\ 0 , & for x < 0\end{matrix} \qquad \text{<} equation b \text{>}$$

In equation b above, u refers to the second inclination of the penetration distance versus the feedback force in the releasing path, x refers to the penetration distance, and F_{f} is a value larger than zero, which has been set to occur when the penetration distance is zero, and may increase in proportion to the cycle number.

After the first cycle is over, the total output energy inside the system is defined by equation 3 below:

OutPut₁=Input₁+GeneratedEnergy₁−E_{b1} [equation 3]

wherein, Eb1 refers to energy released by physical damping of the haptic display during the first cycle, and may be calculated by the equation of E_{b1}=Σₖ₌₁ⁿ[bₘ(Δ\dot{x}(k))²]ΔT.

Such output energy is transferred to the passive human operator within the range of the frequency of interest in the case of haptic, and is again transferred to the system. Therefore, the output energy at the end of the first cycle becomes input energy at the second cycle. The pressing path regarding the second cycle follows equation on the condition that Fᵣ is equal to F_{f} in the releasing path equation of the first cycle. The haptic probe has to penetrate the VE until input energy regarding the second cycle becomes equal to or larger than output energy at the first cycle. Therefore, following equation 4 needs to be satisfied:

$${output}_{1} \leq {input}_{2} \leq {\sum }_{k = 1}^{n} [ f ( k - 1 ) Δ x ( k ) ] \leq {\sum }_{k = 1}^{n} [ ( {K}_{s} x ( k - 1 ) + {F}_{r} ) Δ x ( k ) ] \qquad [ equation 4 ]$$

Because the pressing cycle starts from a non-zero finite value Fᵣ after the first cycle, it can be inferred on the basis of equation 4 that the penetration distance regarding the second cycle will be smaller than the penetration distance regarding the first cycle. It is also clear from equation 1 that the force fₚ₂ at the end of the second pressing cycle will be larger than the force fₚ₁ at the end of the first pressing path. Moreover, the larger the Fᵣ value becomes, the smaller the penetration distance regarding the second cycle will be, and the larger the force will be.

Therefore, although the system generates energy, the penetration distance converges, and the force increases after each cycle. In addition, the penetration distance decreases at each cycle, and the energy generated after each cycle also becomes smaller than that of the previous cycle. Such a phenomenon guarantees that the displayed stiffness increases according to each continuous cycle while the system remains stable.

FIG. 2 illustrates a control structure related to the SSI approach proposed according to the present disclosure. The above-described SSI approach can be implemented through a haptic system having a control structure as illustrated in FIG. 2.

3.2 Detailed Description of Continuous Stiffness Increment Approach

The idea proposed above has been described conceptually. As the number of interaction cycles increases, the penetration distance has become smaller, and the interaction force has become larger. However, equation 1 and equation 2 make no consideration of the stiffness desired in the VE. In order to implement the above-described concept on the basis of a VE with the desired stiffness, two different functions need to be defined to calculate a force regarding a pressing path and a releasing path.

<Function in Pressing Path>

A function for calculating the force during a pressing path is given in equation 5 below:

$$f ( k ) = {f}_{e} ( k ) - ( \frac{{f}_{e} ( k ) - {f}_{p} ( k )}{α} ) \qquad [ equation 5 ]$$

wherein fₑ(k) refers to a force from the VE; fₚ(k) refers to a value from the previous cycle of f(k); and α is a value that determines how abruptly the pressing path increases. The larger the a value is, the larger inclination the pressing path has.

<Function in Releasing Path>

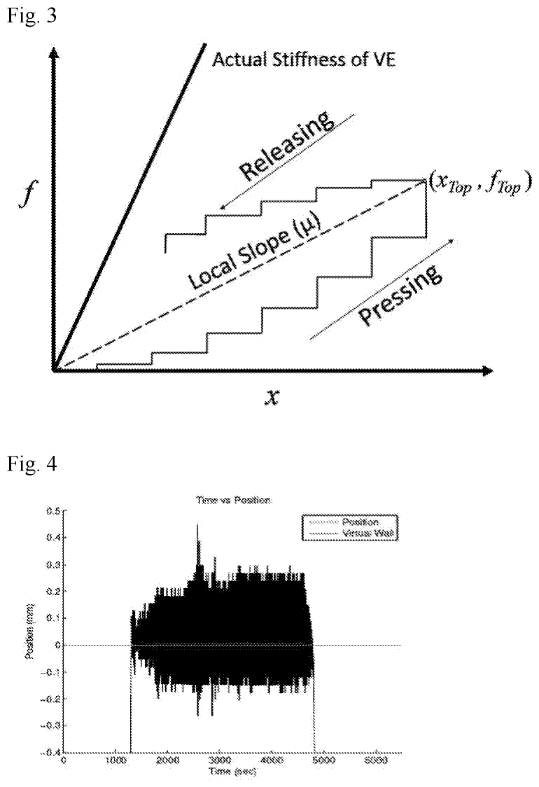

The releasing path starts after the pressing path is completed. FIG. 3 schematically illustrates calculation of a local inclination u according to the present disclosure. The local inclination u is, as illustrated in FIG. 3, calculated as a line extending from the last force and position values (x_{Top}, f_{Top}) of the pressing path to the boundary of the VE. Such a local inclination is calculated only once per each cycle after the pressing path is completed. The local inclination u is calculated as in equation 6 below:

μ=f_{Top}/x_{Top} [equation 6]

wherein f_{Top} refers to the last value of f on the pressing path, and x_{Top} refers to the last value of x on the pressing path.

In the releasing path, the force follows such a local inclination u. As described in section 3.1, the force needs to have a finite value after the releasing path is completed. During the releasing path, the force is defined the function given in equation 7 below:

$$f ( k ) = {f}_{p} ( k ) + ( \frac{{f}_{r} ( k ) - {f}_{p} ( k )}{β} ) \qquad [ equation 7 ]$$

wherein β determines the degree of abruptness the releasing path will have, and it thus means that the larger the β value is, the larger the force value will be when the releasing path is completed. In addition, fᵣ(k) is defined as in equation 8 below:

fᵣ(k)=μx(k) [equation 8]

<Selection of α and β>

In relation to a linear relationship between a force and a position, a stiffness value necessary for generated energy to be released by physical damping of a haptic display is given by equation 9 below according to a passivity condition:

$${K}_{v} \leq \frac{2 {b}_{m}}{Δ T} \qquad [ equation 9 ]$$

wherein bₘ refers to physical damping of the haptic display, and ΔT refers to the sampling time.

As described in section 2, when the system converges after several cycles, there may exist small forward/backward movements near the converging point due to sampling and zero-order hold. Such forward/backward movements generate predetermined energy, and this energy needs to be released by physical damping of the haptic display for the purpose of a smooth haptic interaction without jittering.

The feedback force for the first sample at the start of each pressing path must follow the condition of equation 8, and is defined by equation 10 below:

f(k)=Kᵥx(k)+[fₚ(k)−Kᵥxₚ(k)] [equation 10]

wherein x(k) refers to the current penetration distance, fₚ refers to the value of the previous feedback force, and xₚ(k) refers to the previous penetration distance.

The α value is derived by equations 5 and 10 as defined by equation 11 below:

$$α = \frac{{f}_{e :} ( k ) - {f}_{p} ( k )}{{f}_{e} ( k ) - [ {K}_{v} x ( k ) + ( {f}_{p} ( k ) - {K}_{v} {x}_{p} ( x ) ) ]} \qquad [ equation 11 ]$$

In a manner similar thereto, the feedback force regarding the first sample at the start of each releasing path has to be identical to equation 10, and the β value is derived by equations 7 and 10 as defined by equation 12 below:

$$1 l ′ {3}^{3} - - \frac{{f}_{r} ( k ) - {f}_{p} ( k )}{{K}_{v} x ( k ) + ( {f}_{p} ( k ) - {K}_{v} {x}_{p} ( k ) ) - {f}_{p} ( k )} \qquad [ equation 12 ]$$

As illustrated in FIG. 3, the inclination of the penetration distance versus the feedback force may change according to the penetration distance, even in a single pressing path or releasing path. That is, the inclination of the penetration distance versus the feedback force may be a function of the penetration distance, even in a single pressing path or releasing path.

3.3. Experiments Regarding SSI Approach

3.3.1 Experiment Setting

In order to evaluate the performance of the approach proposed by the present disclosure, an experiment was performed by using PHANToM Premium 1.5, which commercially available haptic equipment, on a single-DOF impedance type haptic display. Basic details are as follows: the maximum force output is 8.5 N; continuously applicable force is 1.4 N; physical damping (bₘ) is 0.0002 Ns/mm; accordingly, Kv is 0.4 N/mm according to equation 9, the encoder resolution is 0.03 mm, and the sampling rate is 1 kHz.

The interaction with the VE of the haptic probe is modeled as a simple spring as defined by equation 13 below:

$${f}_{e} ( n ) = \{ \begin{matrix}k x ( n ) , & for x ( n ) \geq 0 \\ 0 , & for x ( n ) < 0\end{matrix} \qquad [ equation 13 ]$$

wherein x(n) refers to the penetration distance into the VE of the haptic probe, and k refers to the stiffness of the VE.

3.3.2 Experiment Evaluation

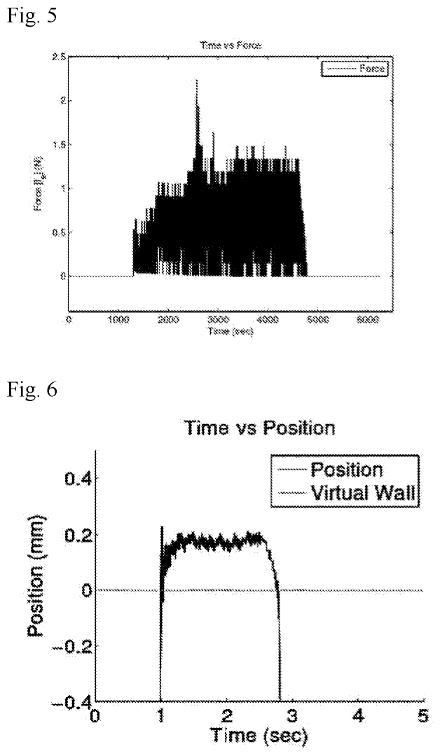

Experiments were performed, with or without a control law, with regard to virtual walls having various stiffnesses. FIG. 4 and FIG. 5 illustrate an unstable haptic interaction regarding a virtual wall having a stiffness of 5 N/mm. Generated energy is larger than the amount that can be released by physical damping of the system by at least a predetermined degree, and responses accordingly exhibit unstable behaviors.

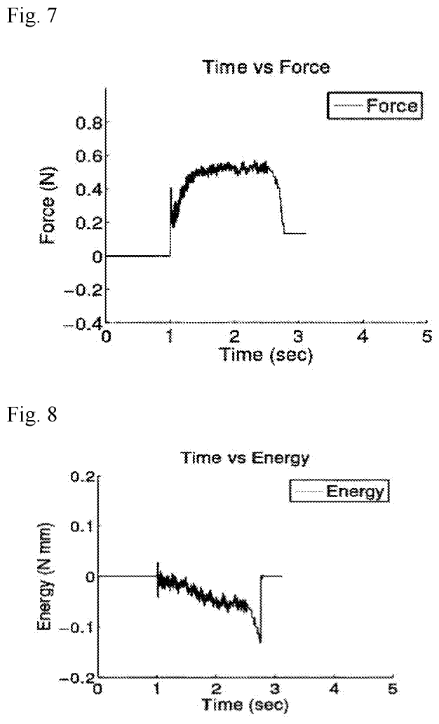

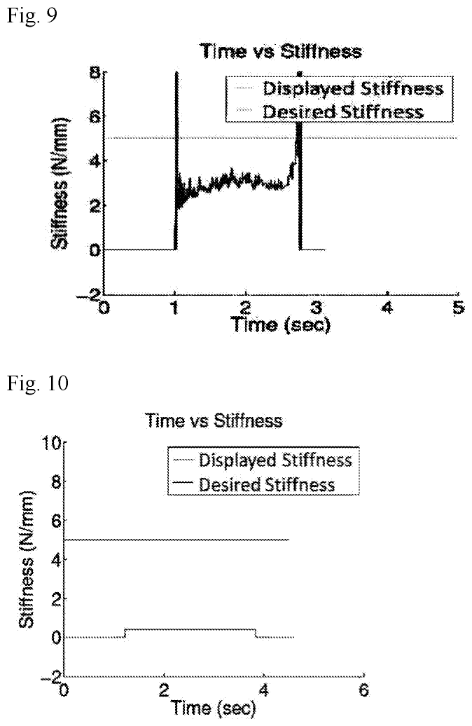

FIG. 6 to FIG. 9 illustrate results obtained by implementing the SSI approach according to the present disclosure under the same experiment condition as that of FIG. 4. As illustrated in FIG. 6 and FIG. 7, position and force responses are stable, and the operator feels no vibration. Although the generated energy was larger than the energy that could be released by the haptic display, the penetration distance converged, the energy generated after several cycles became sufficiently small to be released by physical damping of the system, and the haptic interaction accordingly maintained stability. FIG. 9 illustrates a displayed stiffness that became close to the desired stiffness of the virtual wall.

3.3.3 Comparison with Force Bounding Approach

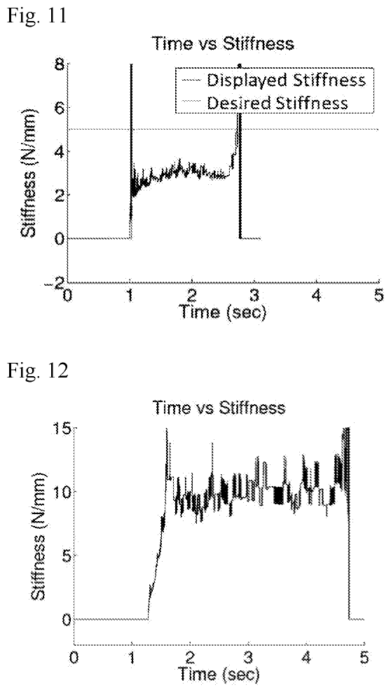

A comparison was made between a force bounding approach and a SSI approach proposed in the present disclosure in order to display a desired stiffness. Experiments were performed with regard to both approaches by using PHANToM Premium 1.5, and the value of physical damping bₘ was selected to be 0.0002 Ns/mm. FIG. 10 to FIG. 12 illustrate a comparison between the SSI approach according to the present disclosure and the force bounding approach (FBA). It is clear from FIG. 10 that, when the stiffness of the VE is 5 N/mm, the maximum displayed stiffness of the FBA is about 0.4 N/mm. In contrast, it is clear from FIG. 11 that the displayed stiffness of the SSI approach is about 3 N/mm, a much larger stiffness being accomplished than the FBA. In addition, as illustrated in FIG. 12, if the stiffness of the VE is increased to 100 N/mm, the displayed stiffness increases to about 10 N/mm. Meanwhile, the force increases after several cycles, and even a small-scale change in the penetration distance causes a shift of the value of the displayed stiffness. Accordingly, the displayed stiffness undergoes slight fluctuation. For reference, the high-stiffness VE was not stabilized by a time-domain passivity approach (TDPA).

3.4 Conclusion

The present disclosure has proposed a new concept of a stable haptic interaction method for further extending the stiffness range that can be accomplished by impedance-type haptic displays. In order to continuously increase the displayed stiffness, two separate functions regarding a pressing area and a releasing area, respectively, have been defined in such a manner that, while generated energy can be released by intrinsic physical damping of the device, the displayed stiffness can gradually increase so as to approach the desired value. Since the proposed approach continuously increases the displayed force at a continuous cycle of the interaction without any abrupt change of the force, the operator recognizes no stiffness change. The largest advantage of the approach proposed by the present disclosure, compared with the prior art, is the fact that it is possible to implement, through the SSI approach, a much larger actually displayed stiffness than those of other approaches such as TDPA, FBA, and energy bounding approach (EBA). It has been proven through experiments using PHANToM that the approach proposed in the present disclosure can provide an extended stiffness range and a high actually displayed stiffness compared with other approaches. Meanwhile, the concept presented in the present disclosure is also applicable to remote systems and multi-DOF interactions.

The above disclosure may be included in the following claims.

1. A method for providing a haptic augmented reality through a haptic device, the method comprising:

setting a desired stiffness of a virtual environment by a controller of the haptic device, a desired feedback force being defined according to a desired inclination of a penetration distance versus a feedback force such that the same occurs so as to correspond to a penetration distance into the virtual environment at the desired stiffness, and the penetration distance being a distance by which one end of the haptic device enters the virtual environment;

generating a feedback force according to a stiffness lower than the desired stiffness by a driver of the haptic device while repeating a cycle during which one end of the haptic device moves along a pressing path and a releasing path, the penetration distance into the virtual environment increasing along the pressing path and decreasing in the releasing path; and

conducting a control by the controller of the haptic device such that the feedback force following the penetration distance at each cycle increases compared with the feedback force of the previous cycle, the penetration distance of one end of the haptic device converges at a predetermined location as the cycle is repeated, and the inclination of the penetration distance of the converging location versus the feedback force occurring at the converging location arrives the desired inclination.

2. The method of claim 1, wherein the feedback force occurring in the pressing path is defined by equation a below:

$$J ( x ) = \{ \begin{matrix}{K}_{s} x + {F}_{r} , & for x \geq 0 \\ 0 , & for x < 0\end{matrix} \qquad \text{<} equation a \text{>}$$

In equation a above, Kₛ refers to the first inclination of the penetration distance versus the feedback force in the pressing path; x refers to the penetration distance; and Fᵣ is zero at the first cycle, and is then the value of the feedback force at the last location in connection with the movement along the releasing path of the previous cycle.

3. The method of claim 1, wherein the feedback force occurring in the releasing path is defined by equation b below:

$$J ( x ) = \{ \begin{matrix}μ x + {F}_{f} , & for x \geq 0 \\ 0 , & for x < 0\end{matrix} \qquad \text{<} equation b \text{>}$$

In equation b above, u refers to the second inclination of the penetration distance versus the feedback force in the releasing path, x refers to the penetration distance, and F_{f} is a value larger than zero, which has been set to occur when the penetration distance is zero, and increases in proportion to the cycle number.

4. The method of claim 2 or 3, wherein the first inclination or the second inclination is a function of the penetration distance.

5. A system for providing a haptic augmented reality through a haptic device, the system comprising:

a controller configured to set a desired stiffness of a virtual environment and to determine a feedback force according to a stiffness lower than the desired stiffness, the feedback force being generated while repeating a cycle during which one end of the haptic device moves along a pressing path and a releasing path, the penetration distance into the virtual environment increasing along the pressing path and decreasing in the releasing path, the penetration distance being a distance by which one end of the haptic device enters the virtual environment; and

a driver configured to drive a feedback force to the haptic device by the force determined by the controller, wherein

a desired feedback force is defined according to a desired inclination of a penetration distance versus a feedback force such that the same occurs so as to correspond to a penetration distance into the virtual environment at the desired stiffness;

the inclination of the penetration distance versus the feedback force occurring according to a stiffness lower than the desired stiffness is smaller than the desired inclination; and

the controller conducts a control such that the feedback force following the penetration distance at each cycle increases compared with the feedback force of the previous cycle, the penetration distance of one end of the haptic device converges at a predetermined location as the cycle is repeated, and the inclination of the penetration distance of the converging location versus the feedback force occurring at the converging location arrives the desired inclination.

6. The system of claim 5, wherein the feedback force occurring in the pressing path is defined by equation a below:

$$f ( ϰ ) = \{ \begin{matrix}{K}_{s} ϰ + {F}_{r} , for ϰ \geq 0 \\ 0 , for ϰ < 0\end{matrix} \qquad < equation a >$$

In equation a above, Kₛ refers to the first inclination of the penetration distance versus the feedback force in the pressing path; x refers to the penetration distance; and Fᵣ is zero at the first cycle, and is then the value of the feedback force at the last location in connection with the movement along the releasing path of the previous cycle.

7. The system of claim 5, wherein the feedback force occurring in the releasing path is defined by equation b below:

$$f ( ϰ ) = \{ \begin{matrix}μ ϰ + {F}_{f} , for ϰ \geq 0 \\ 0 , for ϰ < 0\end{matrix} \qquad < equation b >$$

In equation b above, u refers to the second inclination of the penetration distance versus the feedback force in the releasing path, x refers to the penetration distance, and F_{f} is a value larger than zero, which has been set to occur when the penetration distance is zero, and increases in proportion to the cycle number.

8. The system of claim 6 or 7, wherein the first inclination or the second inclination is a function of the penetration distance.

9. A computer-readable storage medium in which a computer program is recorded, wherein the computer program, when executed by a processor, causes a computer to execute the method according to one of claims 1 to 3.

4. Successive Force Augment (SFA) Approach

Hereinafter, another embodiment of the present disclosure will be described with reference to the accompanying drawings.

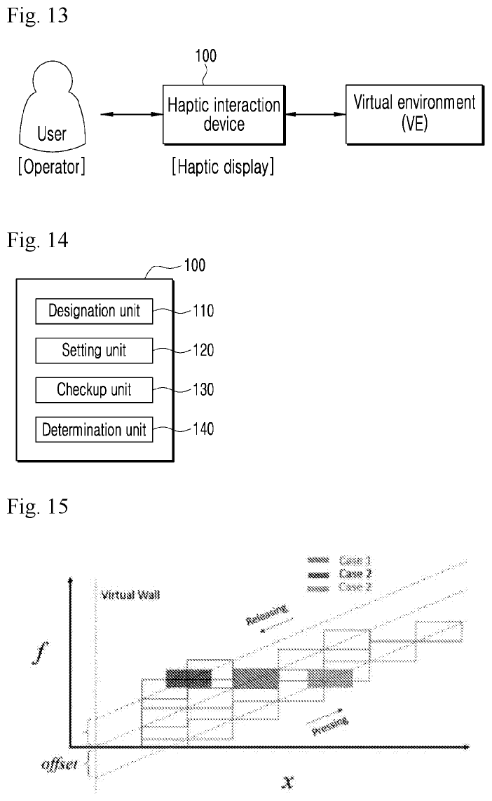

FIG. 13 illustrates a haptic interaction system according to another embodiment of the present disclosure.

As illustrated in FIG. 13, a haptic interaction system according to another embodiment of the present disclosure may include a haptic interaction device 100 configured to provide a haptic interaction between an operator (a user) and a VE.

In connection with the configuration of such a haptic interaction system, analysis of system stability is an importance standard never to be neglected, and improving system transparency and expanding the impedance range will also be important tasks.

Various approaches have been proposed to improve system transparency while guaranteeing stability, and passivity among the same could be regarded as an important mathematical means related to the haptic interaction regardless of system parameters.

For example, a time-domain passivity approach, an energy bounding algorithm, and a force bounding algorithm have been derived from such a passivity theory and proposed to guarantee a stable haptic interaction.

However, most of the above approaches that guarantee a stable haptic interaction sacrifice the stiffness during the interaction in order to secure stability.

Accordingly, another embodiment of the present disclosure seeks to propose, in connection with a VE-based haptic interaction, a new approach for implementing a high-stiffness haptic interaction provided that stability is guaranteed, and the configuration of a haptic interaction device 100 for implementing the same will hereinafter be described in more detail.

FIG. 14 illustrates a schematic configuration of a haptic interaction device 100 according to another embodiment of the present disclosure.

As illustrated in FIG. 14, the haptic interaction device 100 according to another embodiment of the present disclosure may include: a designation unit 110 configured to designate a desired stiffness in a VE; a setting unit 120 configured to set a state-dependent linear feedback force; a checkup unit 130 configured to check the stiffness; and a determination unit 140 configured to determine a feedforward force offset value in connection with the feedback force.

All or at least a part of the configuration of the haptic interaction device 100 including the above-mentioned designation unit 110, the setting unit 120, the checkup unit 130, and the determination unit 140 may be implemented as a hardware module or as a software module, or as a combination of a hardware module and a software module.

As used herein, the software module may be understood as an instruction executed by a processor that performs operations inside the haptic interaction device 100, and such an instruction may be mounted in a memory inside the haptic interaction device 100.

The haptic interaction device 100 according to another embodiment of the present disclosure, which has the above-described configuration, adopts a successive force augment (SFA) approach that uses the feedforward force offset value as a means for guaranteeing stability of haptic interaction and implementing a high stiffness, and each constituent element inside the haptic interaction device 100 related thereto will hereinafter be described in more detail.

The designation unit 110 is configured to designate a desired stiffness in the VE.

More specifically, the designation unit 110 designates a desired stiffness relates to a penetration depth of a haptic interaction point (HIP) and a feedback force corresponding to the penetration depth.

As used herein, the HIP refers to the position of the user's hand in the VE, and may be understood as the position of the probe of the device that provides the user with haptic information.

The desired stiffness may be derived from a desired inclination that indicates the correlation between the penetration depth of the HIP in the VE and the feedback force corresponding to the penetration depth.

The setting unit 120 is configured to set a feedback force. More specifically, when a desired stiffness in the VE is designated, the setting unit 120 sets a feedback force configured such that the HIP penetrates the VE.

The feedback force that is set in this regard may be expressed by equation 14 below:

f(n)=Kx(n)+offset [equation 14]

wherein K refers to the stiffness in the VE, and x(n) refers to the penetration depth of the HIP.

In equation 14 above, “offset” refers to the offset value of the feedforward force, and has an attribute independent of the system state. Accordingly, the same eliminates instability of the interaction and also serves as an important parameter that changes the stiffness.

In this regard, FIG. 15 illustrates three cases (Case 1, Case 2, and Case 3) in connection with different feedforward force offset values, which will now be described.

Case 1: the offset value is zero.

The force from the user (operator) converges at the same point as in the case of the feedback force from the VE. A small forward/backward movement exists at the converging point due to quantization and zero-order hold (ZOH), and the corresponding converging area is indicated by a green box in FIG. 15.

Case 2: the offset value is a positive value.

Assuming that the same force is applied by the user (operator) as that in Case 1, it is clear that the converging point further moves leftward compared with Case 1. This is because the feedback force becomes equal to the force from the user (operator) at a penetration depth smaller than that of Case 1, and a larger stiffness is accordingly exhibited than in Case 1.

Case 3: the offset value is a negative value.

When the same force is applied by the person (operator) as in Case 1 and Case 2, the feedback force becomes equal to the force from the person (operator) at a larger penetration depth. Therefore, the converging point further moves rightward compared with Case 1, and it can be understood that a lower stiffness than that of Case 1 is exhibited.

In summary, the displayed stiffness is largest in connection with Case 2, is lower in Case 1, and is the smallest in connection with Case 3. Meanwhile, the setting unit 120 may make settings such that energy accumulated by the feedback force at each cycle is smaller than the magnitude of physical damping unique to the haptic device.

As used herein, a cycle refers to a period during which a HIP penetrates a VE along a pressing path by means of a feedback force and then moves out of the VE along a releasing path by means of physical damping energy.

The reason the feedback force is set to be smaller than the magnitude of physical damping energy is for the purpose of counterbalancing energy occurring in the interaction process by the physical damping energy, thereby guaranteeing stability of the haptic interaction.

The checkup unit 130 is configured to check the stiffness at the cycle.

More specifically, the HIP penetrates the VE along a pressing path according to a feedback force that has been set and then moves out of the VE along a releasing path by means of damping energy, thereby completing a cycle. When each cycle is ended, the checkup portion 130 checks the stiffness at the corresponding cycle.

The determination unit 140 is configured to determine a feedforward force offset value regarding the feedback force at the next cycle.

More specifically, on the basis of a result of comparing a stiffness checked at a cycle and a desired stiffness of the VE, the determination unit 140 determines a feedforward force offset value related to the feedback force at the next cycle that is adjacent to the ended cycle.

When the stiffness checked at the cycle is smaller than the desired stiffness of the VE by at least a threshold value, the feedforward force offset value is set to be larger than the offset value at the adjacent previous cycle. In contrast, when the stiffness checked at the cycle is larger than the desired stiffness by at least the threshold value, the feedforward force offset value is set to be smaller than the offset value at the adjacent previous cycle.

In addition, when the difference between the stiffness checked at the cycle and the desired stiffness is within the threshold value, the feedforward force offset value is determined to toggle with reference to the offset value at the adjacent previous cycle.

Meanwhile, when the cycle is the initial cycle configured such that the HIP penetrates the VE, the value is determined to be zero.

In summary, the feedforward force offset value according to another embodiment of the present disclosure starts from zero and gradually increases over respective interaction cycles until the interaction stiffness becomes larger than or equal to the desired stiffness of the VE. Once the interaction stiffness reaches the desired stiffness, the feedforward force offset value is toggled such that the same can be maintained at the desired stiffness.

Hereinafter, detailed operations of the haptic interaction device 100 will be described with reference to equations and drawings for better understanding.

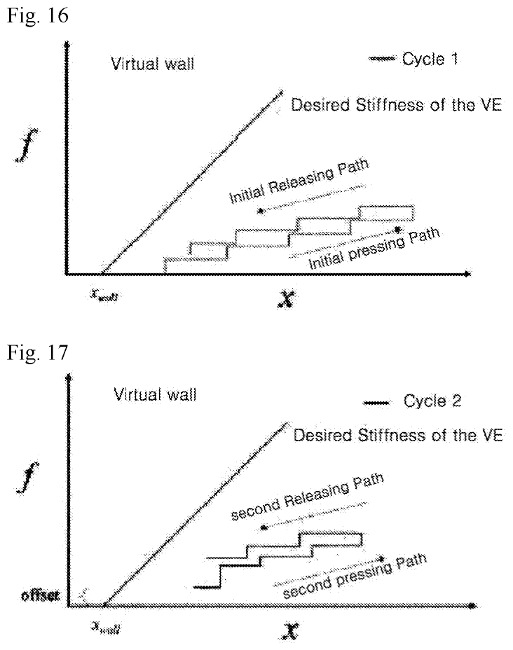

First, one cycle will be described conceptually each time with reference to the penetration depth versus feedback force graphs illustrated in FIG. 16 and FIG. 17.

The stiffness configured such that generated energy can be dissipated by physical damping energy of the device regarding the linear relationship between the feedback force and the penetration depth is given as a passivity condition defined by equation 15 below:

$${K}_{virtual} \leq \frac{2 {b}_{m}}{Δ T} \qquad [ equation 15 ]$$

wherein bₘ refers to physical damping, and ΔT refers to sampling time.

A state-dependent feedback force regarding haptic interaction is defined by equation 16 below:

$$f ( n ) = \{ \begin{matrix}{K}_{u} ( x ( n ) - {x}_{wall} ) + Offset , for x ( n ) \geq {x}_{wall} \\ 0 , for x ( n ) < {x}_{wall}\end{matrix} \qquad [ equation 16 ]$$

wherein f(n) refers to feedback force, Kᵥ refers to a stiffness selected such that Kᵥ<Kᵥᵢᵣₜᵤₐₗ, and x(n) refers to the penetration depth.

The offset value regarding Cycle 1 is zero. Therefore, the penetration depth versus feedback force related to Cycle 1 is as illustrated in FIG. 16.

After Cycle 1, that is, when the pressing path and the releasing path are over, the stiffness is given as in equation 17 below:

$${K}_{displayed} ( n ) = \frac{f ( n )}{ϰ ( n ) - {ϰ}_{wall}} \qquad [ equation 17 ]$$

The stiffness is compared with the desired stiffness when each cycle is over. The offset value is decreased or increased by a defined by equation 16 according to whether the stiffness is larger or smaller than the desired stiffness.

Since the inclination Kᵥ is taken to be smaller than Kᵥᵢᵣₜᵤₐₗ by some degree, and in view of equation 15, the offset value may be increased or decreased by the value defined by equation 18 below after each cycle:

$$α = [ \frac{2 {b}_{m}}{Δ T} ( x ( n ) - {ϰ}_{wall} ) + f ( k - 1 ) - \frac{2 {b}_{m}}{Δ T} ( x ( n - 1 ) - {ϰ}_{wall} ) ] - f ( n ) \qquad [ equation 18 ]$$

The smaller the Kᵥ value is, the larger the α value becomes after each cycle. The larger the Kᵥ value is, the smaller the a value becomes after each cycle.

The offset value keeps increasing with regard to Cycle 1 until the stiffness becomes larger or equal to the desired stiffness in connection with equation 19 below, as illustrated in FIG. 17. Thereafter, the offset value is toggled such that the same is maintained close to the desired stiffness.

$$offset = \{ \begin{matrix}Offset + α , for {K}_{displayed} \leq {K}_{desired} \\ Offset - α , for {K}_{displayed} > {K}_{desired}\end{matrix} \qquad [ equation 19 ]$$

Energy generated during the haptic interaction is defined by equation 20 below:

$${E}_{g} ( n ) = {\sum }_{k = 1}^{n} [ f ( k - 1 ) \dot{ϰ} ( k ) ] Δ T \qquad [ equation 20 ]$$

wherein f(k−1) refers to feedback force from the last sample, and \dot{x}(k) refers to the velocity of the device.

Energy dissipated by haptic interaction is defined by equation 21 below:

$${E}_{b} ( n ) = {\sum }_{k = 1}^{n} [ {{b}_{m} ( \dot{ϰ} ( k ) )}^{2} ] Δ T \qquad [ energy 21 ]$$

A stable interaction can be maintained by using a stiffness smaller than Kᵥᵢᵣₜᵤₐₗ. This is because all energy generated during interaction can be dissipated by physical damping.

Additional energy generated by the offset value may partially exist, and there may be a case in which the same is larger than what can be dissipated by damping unique to the device.

However, energy generated additionally as such is resupplied to the system in the pressing path of the next cycle, and the system can accordingly be maintained stably during the interaction.

This is related to equation 22 below:

E(n)=E^{g}(n)+E^{b}≥00 [equation 22]

As described above, according to the configuration of the haptic interaction device 100 according to another embodiment of the present disclosure, interaction stability and high stiffness can be guaranteed by adopting a successive force augment (SFA) approach that uses a feedforward force offset value.

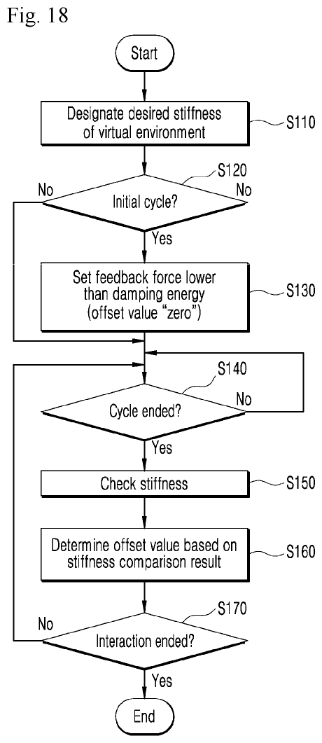

Having descripted the configuration of the haptic interaction device 100 according to another embodiment of the present disclosure, the flow of operations of the haptic interaction device 100 according to another embodiment of the present disclosure will now be described with reference to FIG. 18.

First, the designation unit 110 designates a desired stiffness related to a penetration depth of a haptic interaction point (HIP) in a VE and a feedback force corresponding to the penetration depth in step S110.

The desired stiffness may be derived from a desired inclination that indicates a correlation between the penetration depth of the HIP in the VE and the feedback force corresponding to the penetration depth.

When it is confirmed in step S120 that the initial cycle is started after the desired stiffness in the VE is designated, the setting unit 120 sets in step S130 a feedback force, which is to be input at the initial cycle, to be smaller than the magnitude of the physical damping energy.

When the feedback force at the initial cycle is set, the determination unit 140 determines the feedforward force offset value related to the feedforward force to be zero.

When it is confirmed in step S140 that a cycle is ended, during which the HIP penetrates the VE along a pressing path according to a feedback force that has been set and then moves out of the VE along a releasing path by means of damping energy, the checkup unit 130 checks the stiffness at the corresponding cycle in step S150.

On the basis of the result of comparing the stiffness checked at the cycle and the desired stiffness of the VE, the determination unit 140 then determines a feedforward force offset value related to the feedback force at the next cycle that is adjacent to the ended cycle.

When the stiffness checked at the cycle is smaller than the desired stiffness of the VE by at least a threshold value, the feedforward force offset value is set to be larger than the offset value at the adjacent previous cycle. In contrast, when the stiffness checked at the cycle is larger than the desired stiffness of the VE by at least the threshold value, the feedforward force offset value is set to be smaller than the offset value at the adjacent previous cycle.

In addition, when the difference between the stiffness checked at the cycle and the desired stiffness is within the threshold value, the feedforward force offset value is determined to toggle with reference to the offset value at the adjacent previous cycle.

In this case, the setting unit 120 sets the feedback force at the following cycle to be smaller than the magnitude of the physical damping energy, as in the case of setting the feedback force at the initial cycle.

The above operations of the haptic interaction device 100 through steps S140 to S160 are repeated until it is confirmed in step S170 that interaction with the VE is ended.

It is clear from the above description of the flow of operations by the haptic interaction device 100 according to another embodiment of the present disclosure that stability of haptic interaction and high stiffness can be advantageously guaranteed by adopting a successive force augment (SFA) approach that uses a feedforward force offset value.

The fact that the present disclosure can accomplish the above-mentioned advantageous effect can be further proved through a research in the following experiment section.

Experiment Regarding SFA Approach

A. Experiment Setup

In order to evaluate the performance of the approach proposed by the present disclosure in connection with a single-DOF impedance type haptic display, PHANToM Premium 1.5 was used. Basic details are as follows: the maximum force output is 8.5 N; continuously applicable force is 1.4 N; the encoder resolution is 0.03; and the sampling rate is 1 kHz; physical damping (bₘ) of the haptic display, by which the system is stabilized, is selected to be 0.00050 Ns/mm. Accordingly, the maximum stiffness of the VE, which makes the haptic interaction stable, is 1 N/mm according to equation 15. AS described above, Kᵥ regarding equation 16 may be any value smaller than 1 N/mm, and was selected to be 0.8 N/mm.

The interaction of the haptic probe with the VE was modeled as a simple virtual spring as defined by equation 23 below:

$${f}_{c} ( n ) = \{ \begin{matrix}k ϰ ( n ) , for ϰ ( n ) \geq 0 \\ 0 , for ϰ ( n ) < 0\end{matrix} \qquad [ equation 23 ]$$

wherein x(n) refers to the penetration distance of the haptic probe into the VE, and k refers to the actual stiffness of the VE.

B. Experiment Result Evaluation

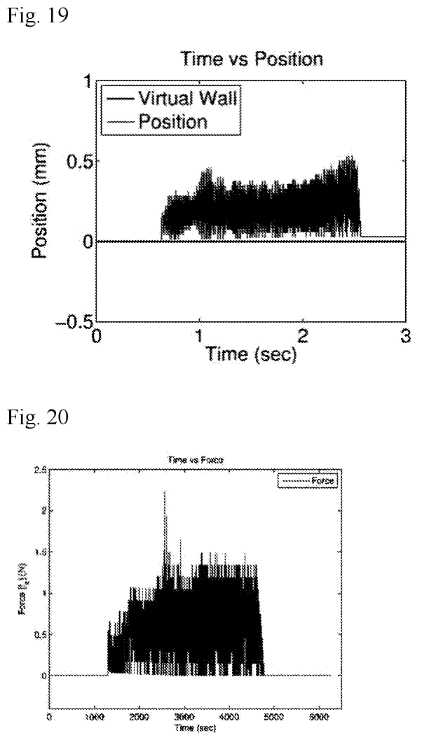

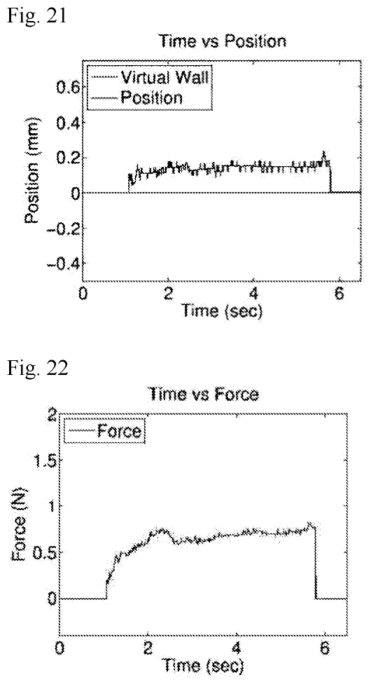

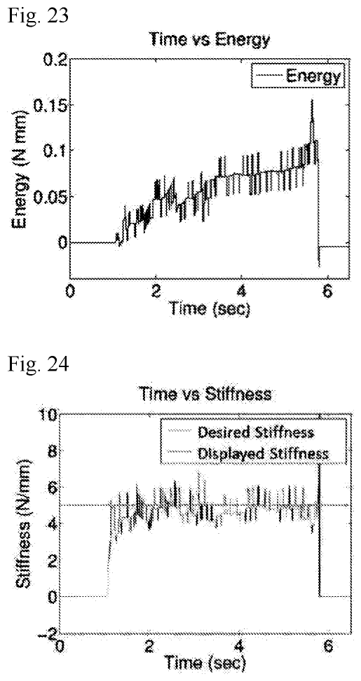

Experiment results regarding a virtual wall having a stiffness of 5 N/mm are illustrated in FIG. 19 and FIG. 20. The generated energy was much larger than what could be dissipated by physical damping of the system, and the response thereof was unstable. FIG. 21 to FIG. 24 illustrate result of experiments performed by using the SFA approach. It is clear from FIG. 21 and FIG. 22 that the position and force during the haptic interaction are stable with regard to time. It can be observed in FIG. 24 that the displayed stiffness is close to the desired stiffness of the virtual wall by a difference of only several millimeters. A stable haptic interaction can be seen from the position and force graph, and the operator cannot feel any vibration in the process of interaction with the VE. Meanwhile, no conventional approach can display a displayed stiffness and a rate-hardness of 3 N/mm or larger by using PHANToM 1.5.

C. Comparison with Force Bounding Approach

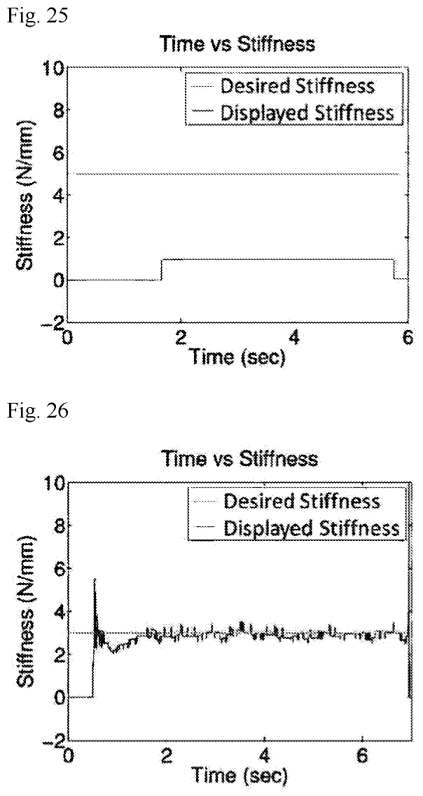

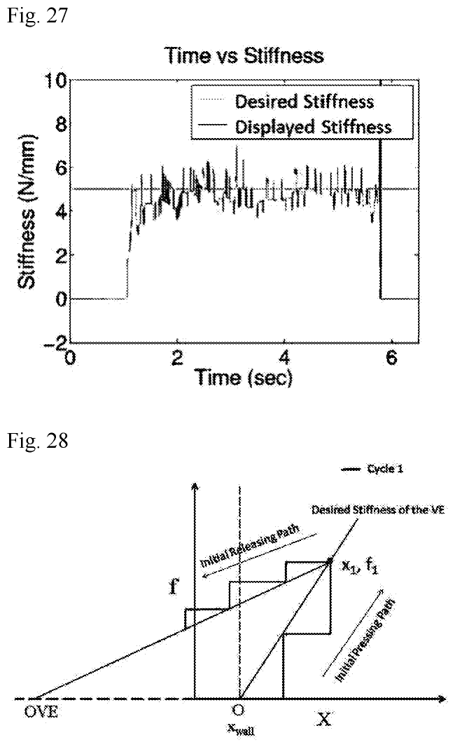

A comparison is made between the SFA approach according to the present disclosure and a force bounding Approach (FBA). Physical damping of PHANToM Premium 1.5 was estimated to be 0.0005 Ns/mm. The desired stiffness was 5 N/mm, but it can be confirmed that the FBA limits the displayed stiffness to about 1 N/mm (FIG. 25). In contrast, the SFA approach according to the present disclosure exhibits a stiffness of 5 N/mm, which is identical to the desired stiffness (FIG. 27). Meanwhile, the force increases after several cycles such that even a small-scale change in the penetration distance causes a shift of the displayed stiffness value, and the displayed stiffness accordingly has slight fluctuation.

D. Conclusion

The present disclosure has proposed a new approach for improving the displayed stiffness of an impedance-type haptic display. Unlike other approaches, the proposed approach uses a feedforward force offset value that increases gradually, thereby avoiding a tradeoff between performance and stability, and making it possible to exhibit an impedance that is close to the desired value. The SFA approach uses a low stiffness in connection with rendering that is state-dependent on the feedback force, thereby guaranteeing stability, and the generated energy can accordingly be dissipated by damping. The small offset value of the state-dependent feedforward force increases at each interaction cycle such that the accomplished stiffness value can reach the desired stiffness without disturbing the system stability. Since the force changes gradually in this manner, the user feels no abrupt vibration in the process of interaction with the VE. Moreover, the SFA approach minimizes the penetration depth of the haptic probe.

Experiment and object analysis were performed by using PHANToM Premium 1.5, and were described in the experiment evaluation section. This proves that the approach according to the present disclosure can increase the displayed stiffness while maintaining stability, and can also minimize the penetration depth of the haptic probe. A comparison/analysis with the force bounding approach was also performed. It was confirmed that the SFA approach can accomplish a displayed stiffness close to the desired stiffness, while the force bounding approach sacrifices the stiffness in order to guarantee stability. The approach according to the present disclosure will be extended to a multi-DOF interaction, and will also be extended to an admittance-type haptic interaction. The approach according to the present disclosure may also be implemented with regard to a teleoperation system.

Another embodiment of the present disclosure has industrial applicability as follows:

According to the haptic interaction device and the method for operating the same according to another embodiment of the present disclosure, a high-stiffness haptic interaction can be implemented provided that stability is guaranteed in connection with a VE-based haptic interaction. As such, the same overcomes the boundary of the prior art and thus can not only be used for the relevant technology, but also have sufficient possibility of marketing or commercial use of the devices to which the same is applied. Accordingly, the present disclosure can be implemented practically and obviously, and thus has industrial applicability.

5. Extended Successive Force Augment (SFA) Approach

Meanwhile, the stiffness in the case of a haptic interaction is normally different from the hardness, which denotes the degree of feeling by the user (operator).

Existing research has proven that the user (operator) recognizes the hardness regarding a virtual wall (wall hardness) by means of the rate of the initial force with regard to the initial velocity when penetrating the surface, that is, the rate-hardness.

In this regard, stabilization of the interaction may be attempted by applying physical damping energy in connection with a haptic interaction, but such an approach of applying damping energy may be a restriction that reduces the hardness related to recognition by the user (operator) when contacting a virtual object.

Accordingly, another embodiment of the present disclosure seeks to propose a new approach capable of improving the rate-hardness related to the user's recognition of a contact in a VE while providing a high stiffness, provided that stability is guaranteed in connection with a VE-based haptic interaction. The configuration of a haptic interaction device 100 for implementing the same will hereinafter be described in more detail.

Meanwhile, the continuous force increment approach adopted in another embodiment of the present disclosure may be a first approach (SFA) for implementing stability and high stiffness, and, in still another embodiment of the present disclosure, the same may be classified as a second approach (extended SFA) for considering stability, high stiffness, and rate-hardness together.

The first approach (SFA) is mainly for the purpose of implementing stability and high stiffness.

The haptic interaction device 100 of the first approach (SFA) according to another embodiment of the present disclosure has already been described, and the configuration of the haptic interaction device 100 for considering stability, high stiffness, and rate-hardness together according to the second approach (extended SFA) will now be described.

Operations of the designation unit 110, the checkup unit 130, and the determination unit 140 are the same as in the case of the first approach, and repeated descriptions thereof will be omitted herein.

The setting unit 120 is configured to set a feedback force for considering the rate-hardness.

More specifically, when a desired stiffness in the VE is designated, the setting unit 120 sets a feedback force such that the HIP penetrates the VE.

In the case of the initial cycle configured for the HIP to penetrate the VE, the setting unit 120 sets a feedback force to be comparable to the desired stiffness for the purpose of improving the rate-hardness.

When the feedback force at the initial cycle is set to be comparable to the desired stiffness in this manner, the rate-hardness related to the user's recognition of a contact in the VE may be improved compared with the rate-hardness of the case in which the feedback force has been set to be smaller than the desired stiffness starting from the initial cycle.

When the feedback force at the initial cycle is set to be comparable to the desired stiffness, the trajectory of the releasing path extends by a setting depth from the virtual wall, which is the boundary of the VE, in the outward direction, which is the direction of escape of the HIP.

This is for the purpose of preventing an abrupt vibration due to an abrupt force drop when the HIP moves out of the VE because the feedback force has been set to be comparable to the desired stiffness.

In summary, according to an embodiment of the present disclosure, when the feedback force at the initial cycle is set to be comparable to the desired stiffness, the trajectory of the releasing path extends by a setting depth from the virtual wall, which is the boundary of the VE, in the outward direction, which is the direction of escape of the HIP, such that the result is as if the boundary of the VE is moved, thereby preventing an abrupt vibration.

Meanwhile, the setting unit 120 sets the feedback force at a cycle following the initial cycle to be smaller than the magnitude of the physical damping energy such that stability and high stiffness can be guaranteed.

Hereinafter, detailed operations of the haptic interaction device 100, when following the second approach (extended SFA), will be described with reference to equations and drawings for facilitating understanding.

A continuous stiffness augment approach has been described above, which increases the stiffness by increasing the feedback force in the course of each interaction cycle including a pressing path and a releasing path.

It is widely known in the art that the system can be stabilized when energy generated during an interaction in a VE is sufficiently small to be dissipated by damping unique to the device.

However, the rate-hardness becomes smaller than the desired value due to rending of a small stiffness in the SFA approach.

Therefore, a scheme for extending the SFA approach for increasing the rate-hardness value to be close to the desired value in the VE will hereinafter be proposed.

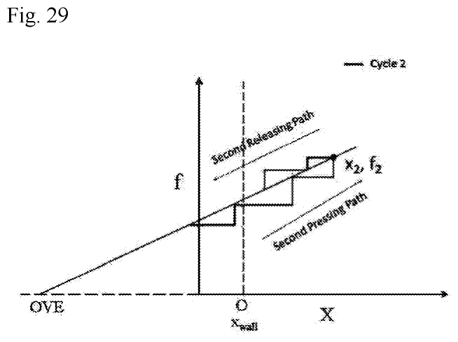

FIG. 28 and FIG. 29 illustrate a concept for making the rate-hardness equal to the desired rate-hardness of the VE.

With regard to the first pressing path, the haptic interaction follows the actual stiffness of the VE as illustrated in FIG. 5. Accordingly, the rate-hardness is improved during a transient response, and the sensed stiffness can also be made equal to the desired stiffness.

A scheme for calculating a force in a free space regarding a simple initial contact may be defined by equation 24 below:

$${f}_{e} ( n ) = \{ \begin{matrix}k ϰ ( n ) , for ϰ ( n ) \geq 0 \\ 0 , for ϰ ( n ) < 0\end{matrix} \qquad [ equation 24 ]$$

wherein x(n) refers to the penetration depth of the haptic probe (haptic interaction point) in the VE, and k refers to the desired stiffness of the VE.

The perceptual hardness of the VE is more closely related to the rate-hardness than the stiffness K of the VE, as defined by equation 25 below:

$${H}_{R} = \frac{f \dot{(} n )}{ϰ \dot{(} n )} \qquad [ equation 25 ]$$

wherein f(\dot{n}) and x(\dot{n}) refer to rates of velocity and force, respectively, in the first pressing path after a contact.

The state-dependent feedback force regarding the haptic interaction, after the first pressing path is ended, is given in equation 26 above by using a low stiffness value Kᵥ.

As illustrated in FIG. 28, energy generated after the ending point of Cycle 1, that is, the first pressing path and the first releasing path, becomes much larger than energy that can be dissipated by damping of the device, as described in equation 26 below:

E₁=E_{g1}+E_{b1}<0 [equation 26]

wherein E_{g1} refers to energy generated after Cycle 1, and E_{b1} refers to energy dissipated by damping of the device after Cycle 1.

However, most of the additionally generated energy is resupplied to the system at the next pressing cycle as is clear from FIG. 17.

In the case of a repeated initial contact pattern which uses a desired stiffness in connection with the pressing path and uses a low stiffness in connection with the releasing path, the VE interaction will become unstable due to the large amount of accumulated active energy.

However, according to the present disclosure, the haptic interaction is configured to follow the SFA approach from the Cycle 2. Accordingly, stable interaction is maintained, and the stiffness is maintained close to the desired stiffness of the VE.

It has become possible to use the SFA approach from Cycle 2 due to the low-stiffness releasing path, but an abrupt force drop may occur when the HIP moves out of the VE.

During a high-force interaction, the HIP easily moves out of the VE due to a high-magnitude pushback force as illustrated in FIG. 29. That is, the x value of the releasing trajectory moves leftward compared with x_{wall}.

Finally, since the HIP moves out of the wall, the given force will be set to be zero. However, this will cause abrupt force jumping that vibrates the haptic interaction.

In order to cope with this problem, the present disclosure extends the trajectory of the releasing path to the x fragment, thereby obtaining a soft force change, and this acts as if the boundary of the VE is moved in relation to equation 27 below:

$${ϰ}_{OVE} = \frac{{K}_{v} {x}_{1} - {f}_{1}}{{K}_{v}} \qquad [ equation 27 ]$$

wherein x₁ refers to the penetration depth, and f₁ refers to the force after the initial pressing path is over. Such a moving interaction point x_{OVE} changes after each cycle according to the feedback force and the penetration depth when each pressing path is ended.

This guarantees that, when an interaction with the VE is performed, or when the HIP moves out of the VE, the force changes slowly. Accordingly, the user (operator) feels no abrupt vibration. The same applies even when the boundary of the VE moves inward or outward during a contact.

As described above, according to the configuration of the haptic interaction device 100 according to an embodiment of the present disclosure, interaction stability and high stiffness are guaranteed by adopting a successive force augment (SFA) approach that uses a feedforward force offset value. In addition, by adopting an extended successive force augment (SFA) approach which sets the feedback force at the initial cycle to be comparable to the desired stiffness, the rate-hardness is advantageously improved in connection with the user's recognition of a contact in the VE while providing a high stiffness, provided that interaction stability is guaranteed.

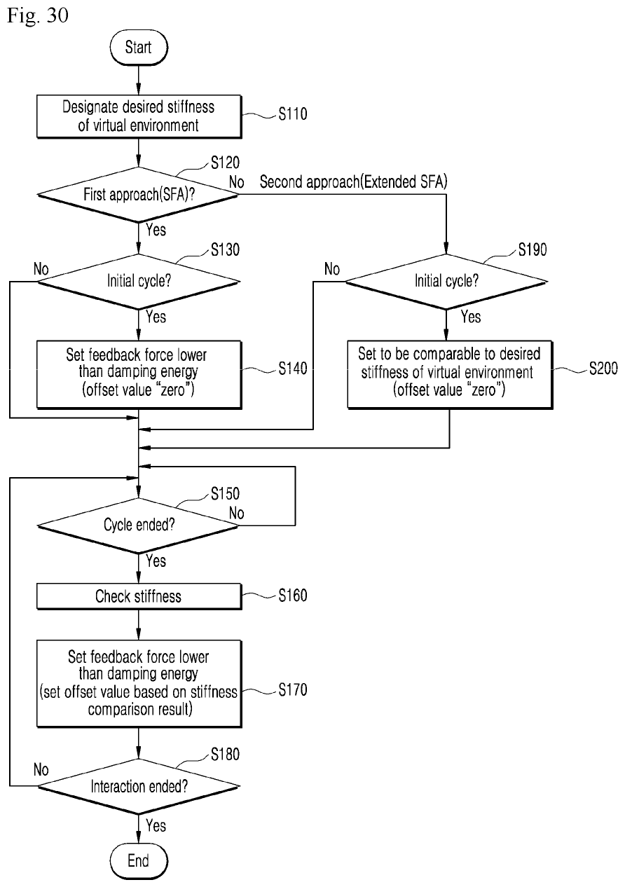

Hereinafter, the flow of operations of the haptic interaction device 100 according to an embodiment of the present disclosure will now be described with reference to FIG. 30.

First, the designation unit 110 designates a desired stiffness related to a penetration depth of a haptic interaction point (HIP) in a VE and a feedback force corresponding to the penetration depth in step S110.

The desired stiffness may be derived from a desired inclination that indicates a correlation between the penetration depth of the HIP in the VE and the feedback force corresponding to the penetration depth.

When it is confirmed in steps S120 and S130 that the first approach (SFA) for implementing stability and high stiffness is followed and that the initial cycle is started after the desired stiffness in the VE is designated, the setting unit 120 sets in step S140 a feedback force, which is to be input at the initial cycle, to be smaller than the magnitude of the physical damping energy.

When the feedback force at the initial cycle is set, the determination unit 140 determines the feedforward force offset value related to the feedforward force to be zero.

When it is confirmed in step S150 that a cycle is ended, during which the HIP penetrates the VE along a pressing path according to the feedback force that has been set and then moves out of the VE along a releasing path by means of damping energy, the checkup unit 130 checks the stiffness at the corresponding cycle in step S150.

On the basis of the result of comparing the stiffness checked at the cycle and the desired stiffness of the VE, the determination unit 140 then determines in step S180 a feedforward force offset value related to the feedback force at the next cycle adjacent to the ended cycle.

When the stiffness checked at the cycle is smaller than the desired stiffness of the VE by at least a threshold value, the feedforward force offset value is set to be larger than the offset value at the adjacent previous cycle. In contrast, when the stiffness checked at the cycle is larger than the desired stiffness by at least the threshold value, the feedforward force offset value is set to be smaller than the offset value at the adjacent previous cycle.

In addition, when the difference between the stiffness checked at the cycle and the desired stiffness is within the threshold value, the feedforward force offset value is determined to toggle with reference to the offset value at the adjacent previous cycle.

In this case, the setting unit 120 sets the feedback force at the following cycle to be smaller than the magnitude of the physical damping energy, as in the case of setting the feedback force at the initial cycle.

The above operations of the haptic interaction device 100 through steps S150 to S170 are repeated until it is confirmed in step S180 that interaction with the VE is ended.

Meanwhile, when it is confirmed in steps S120 and S190 that the second approach (extended SFA) for considering stability, high stiffness, and rate-hardness together is followed and that the initial cycle is started after the desired stiffness in the VE is designated, the setting unit 120 sets in step S200 a feedback force to be comparable to the desired stiffness for the purpose of improving the rate-hardness.

When the feedback force at the initial cycle is set to be comparable to the desired stiffness in this manner, the rate-hardness related to the user's recognition of a contact in the VE may be improved compared with the rate-hardness of the case in which the feedback force has been set to be smaller than the magnitude of the physical damping energy.

When the feedback force at the initial cycle is set to be comparable to the desired stiffness, the trajectory of the releasing path extends by a setting depth from the virtual wall, which is the boundary of the VE, in the outward direction, which is the direction of escape of the HIP.

This is for the purpose of preventing an abrupt vibration due to an abrupt force drop when the HIP moves out of the VE because the feedback force has been set to be comparable to the desired stiffness.

In summary, according to an embodiment of the present disclosure, when the feedback force at the initial cycle is set to be comparable to the desired stiffness, the trajectory of the releasing path is extended by a setting depth from the virtual wall, which is the boundary of the VE, in the outward direction, which is the direction of escape of the HIP, such that the result is as if the boundary is the VE is moved, thereby preventing an abrupt vibration.

Meanwhile, the setting unit 120 sets the feedback force at a cycle following the initial cycle to be smaller than the magnitude of the physical damping energy according to the first approach such that stability and high stiffness can be guaranteed.

As described above, according to the flow of operations by the haptic interaction device 100 according to an embodiment of the present disclosure, interaction stability and high stiffness can be guaranteed by adopting a successive force augment (SFA) approach that uses a feedforward force offset value. In addition, by adopting an extended successive force augment (SFA) approach which sets the feedback force at the initial cycle to be comparable to the desired stiffness, the rate-hardness is advantageously improved in connection with the user's recognition of a contact in the VE while providing a high stiffness, provided that interaction stability is guaranteed. The fact that the present disclosure can accomplish the above-mentioned advantageous effect can be further proven through a research in the following experiment section.

Experiment Regarding Extended SFA Approach

A. Experiment Setup

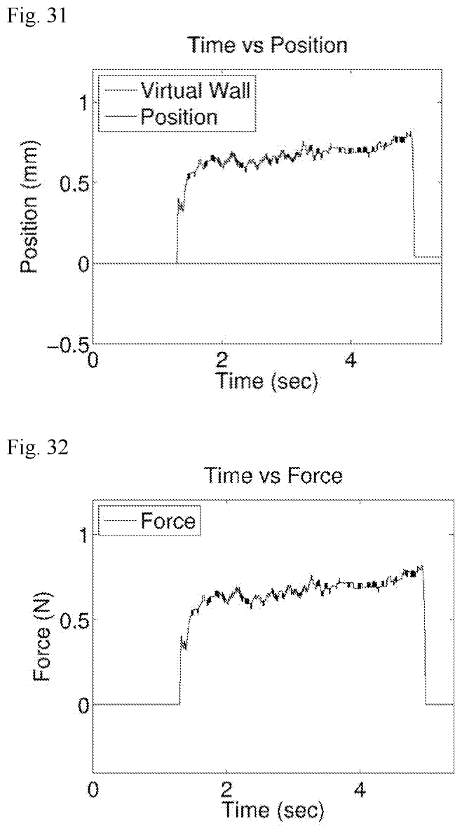

In order to evaluate the performance of the approach proposed by the present disclosure in connection with a single-DOF impedance type haptic display, PHANToM Premium 1.5 was used. Basic details are as follows: the maximum force output is 8.5 N; continuously applicable force is 1.4 N; the encoder resolution is 0.03; the sampling rate is 1 kHz; physical damping (bₘ) of the haptic display, by which the system is stabilized, is selected to be 0.00050 Ns/mm. Accordingly, the maximum stiffness of the VE, which makes the haptic interaction stable, is 1 N/mm according to equation 15. This is illustrated in FIG. 31 and FIG. 32. As described above, Kᵥ regarding equation 3 may be any value smaller than 1 N/mm, and was selected to be 0.8 N/mm.

The interaction of the haptic probe with the VE was modeled as a simple virtual spring as defined by equation 28 below:

$${f}_{e} ( n ) = \{ \begin{matrix}k x ( n ) , for x ( n ) \geq 0 \\ 0 , for x ( n ) < 0\end{matrix} \qquad [ equation 28 ]$$

wherein x(n) refers to the penetration distance of the haptic probe into the VE, and k refers to the stiffness of the VE.

B. Experiment Result Evaluation

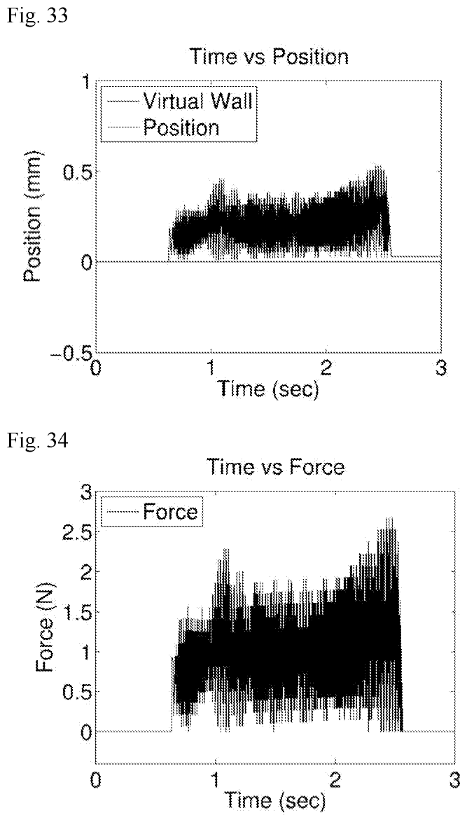

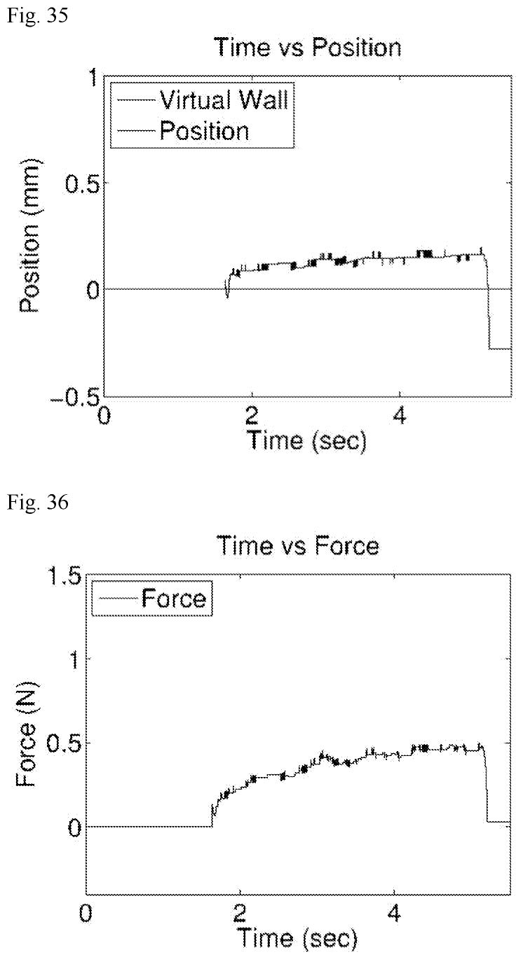

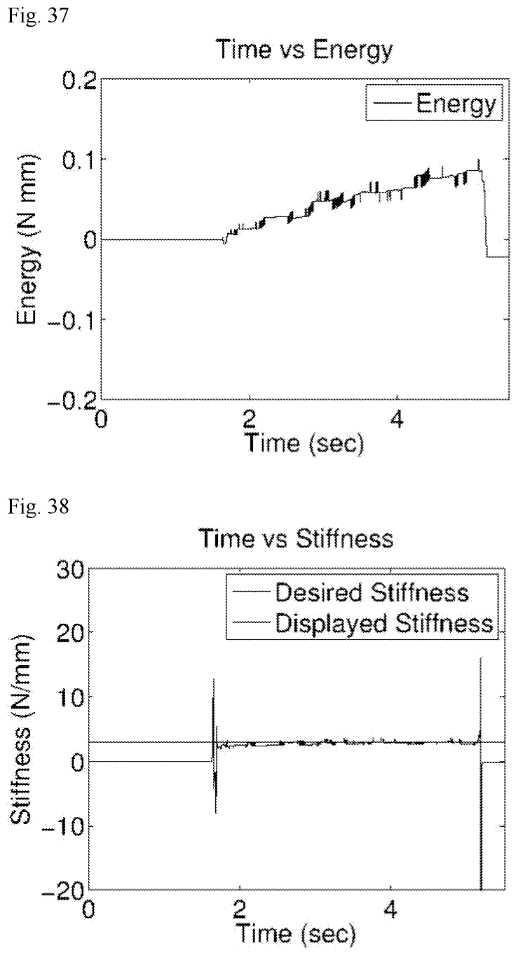

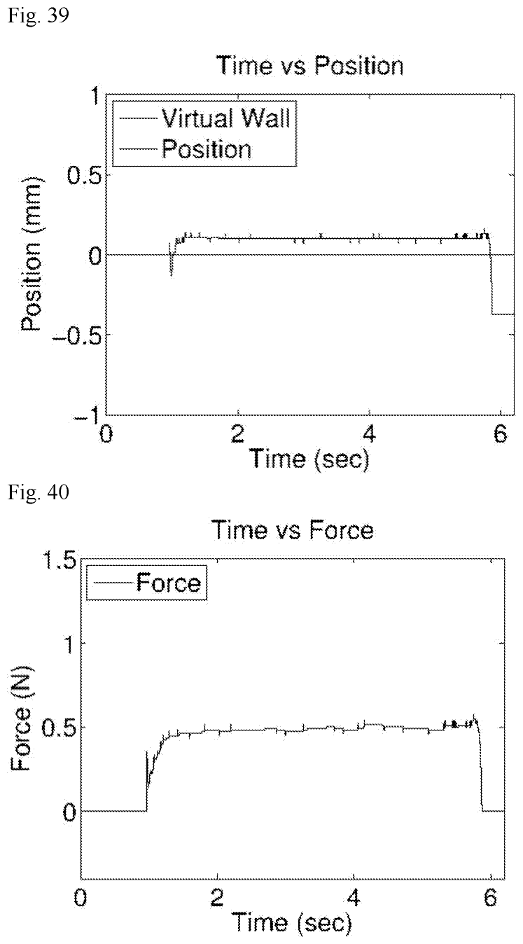

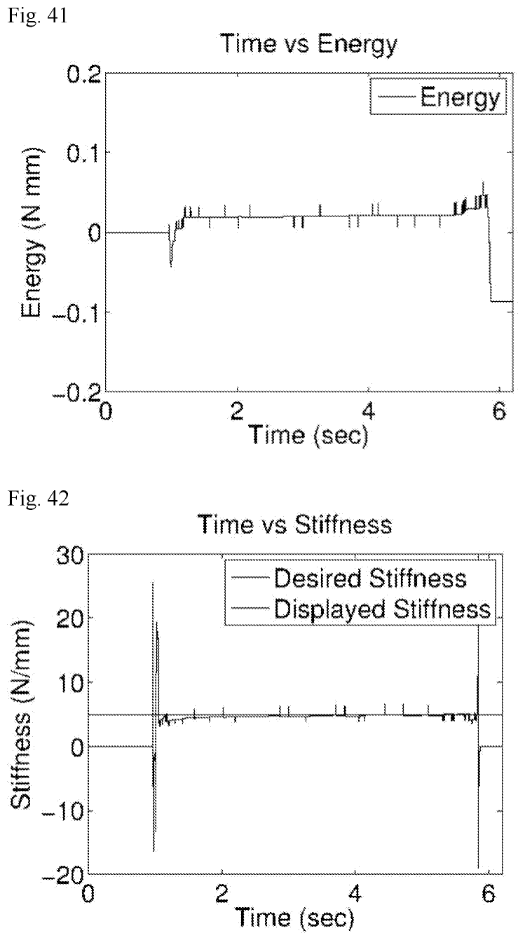

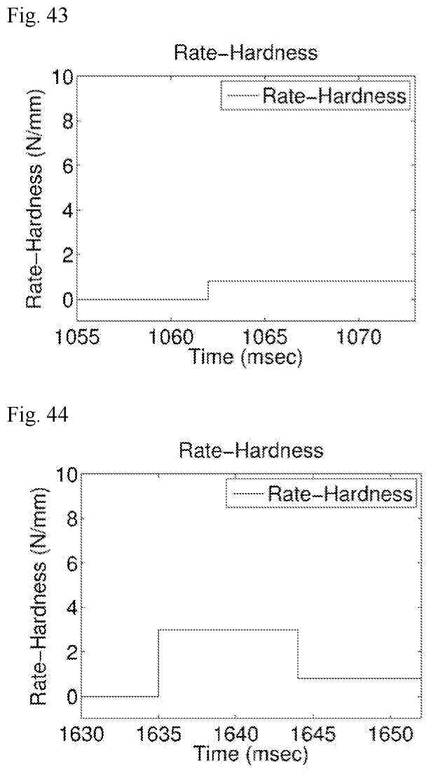

Experiment results regarding a virtual wall having a stiffness of 5 N/mm are illustrated in FIG. 33 and FIG. 34. The generated energy was much larger than what could be dissipated by physical damping of the system, and the response thereof was unstable. FIG. 35 to FIG. 42 illustrate result of experiments performed by using the extended SFA approach. It is clear from FIG. 38 and FIG. 42 that, due to the large feedback force during the first pressing path, the position during the first releasing path has moved out of the initial contact position. Since the accomplished stiffness is calculated as

$$\frac{F}{x - {ϰ}_{wall}} ,$$

the same has a negative value because the force still has a positive value at an x value that is smaller than x_{wall}. After moving out of the VE, the contact point moves by 0.3 mm when interacting with a VE of 3 N/mm and moves by 0.5 mm when interacting with a VE of 5 N/mm. However, the user received no abnormal influence during the test from the load that was maintained due to the moved VE boundary.

C. Subjective Study

The following is a description of a subjective study for distinguishing the sensed stiffness with regard to three different VEs having stiffnesses of 3 N/mm, 4 N/mm, and 5 N/mm, respectively. Healthy males aged between 22 and 28 participated as evaluation subjects. All persons were right-handed and confirmed to have no disability regarding the nerve system or the musculoskeletal system. The subjects were required to distinguish three VEs having different stiffnesses. The subjects were arbitrarily assigned to VEs and required to arrange the same in the ascending order of hardness. While performing the stiffness distinguishing task, the subjects were asked if they felt any movement of each VE out of the initial contact point while the subjects were moving out of the VE.

The result showed that all subjects were able to accurately arrange the arbitrarily assigned VEs in the ascending order (Table 1), and none felt that any VE moved away from the initial contact point (Table 2). This proves that the approach of the present disclosure can accurately display a stiffness that is sensed to be identical to the desired stiffness while maintaining system stability without injecting damping. No conventional approach can display a displayed stiffness and a rate-hardness of 3 N/mm or larger by using PHANToM Premium 1.5.

D. Comparison of Rate-Hardness and SFA Approach

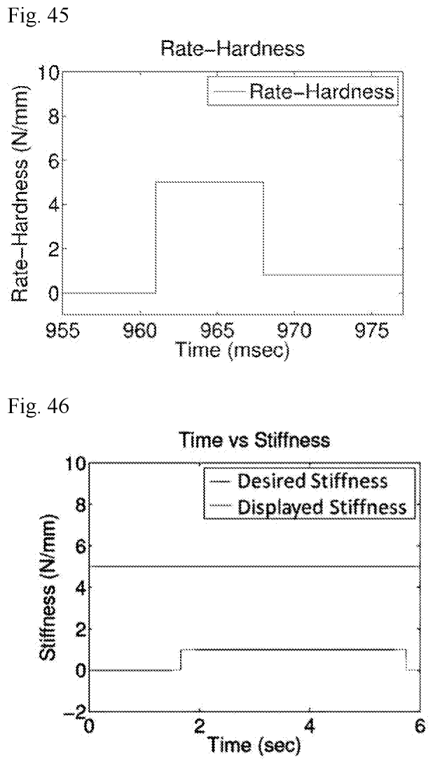

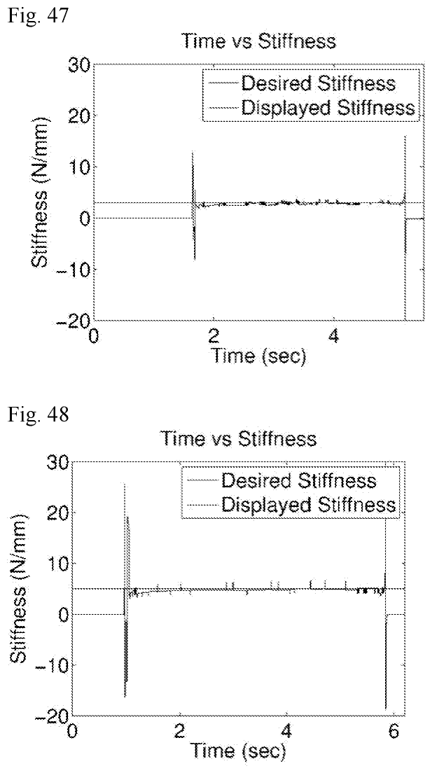

The rate-hardness of the extended SFA approach according to the present disclosure is shown herein and is compared with the SFA approach. According to the SFA approach, the state-dependent linear feedback force is increased by selecting a low stiffness from a point of contact with the VE, and the rate-hardness is accordingly identical to the selected low-stiffness value. This can be confirmed from FIG. 44 and FIG. 45, wherein the initial rate of the force with regard to the initial velocity when penetrating the surface is 0.8 N/mm. On the other hand, FIG. 44 and FIG. 45 show the initial force rate versus the initial velocity in connection with the extended SFA approach that is identical to the case of the VE (that is, 3 N/mm and 5 N/mm). This means that the perceptual hardness is higher in the case of the extended SFA compared with the SFA.

E. Comparison with Force Bounding Approach

A comparison is made between the SFA approach according to the present disclosure and a force bounding Approach (FBA). Physical damping of PHANToM Premium 1.5 was estimated to be 0.0005 Ns/mm. The desired stiffness was 5 N/mm, but the FBA limited the displayed stiffness and rate-hardness to about 1 N/mm (FIG. 46). However, the SFA approach according to the present disclosure exhibited the same rate-hardness as that of the VE and a displayed stiffness of 5 N/mm or less, which is identical to the desired stiffness as illustrated in FIG. 48. The root mean square error of the displayed stiffness and the desired stiffness was 84% in the case of the FBA regarding a VE having a stiffness of 5 N/mm, while the same was 7.52% when the extended SFA approach was used.

It is to be noted that the TDPA was unable to stabilize the VE with such a high stiffness by using PHANToM Premium 1.5.

### CONCLUSION

The present disclosure has proposed a new approach for improving the rate-hardness and the displayed stiffness of an impedance-type haptic display. The proposed approach uses the desired stiffness of the VE in order to display the rate-hardness and to match the displayed stiffness close to the desired stiffness in relation thereto. Unlike other approaches, the approach of the present disclosure neither reduces the force nor injects damping into the system in order to stabilize the system. Accordingly, the perceptual stiffness and transparency are improved. Since the initial pressing path generates a high level of energy, a low stiffness is used in connection with rendering that dissipates energy generated through damping unique to the haptic display. As a result, the SFA approach guarantees stability. A small force offset is increased with regard to each interaction cycle, and this increases the accomplished stiffness value until the desired stiffness is reached. Since the force does not change abruptly but changes gradually, the user feels no abrupt vibration when interacting with the VE.

Experiment and object analysis were performed by using PHANToM Premium 1.5, and were described in the experiment evaluation section. This proves that the approach according to the present disclosure can increase the rate-hardness and the displayed stiffness while maintaining stability. A comparison/analysis with the force bounding approach was also performed. It was confirmed that the approach according to the present disclosure can obtain larger rate-hardness and displayed stiffness. The approach according to the present disclosure will be extended to a multi-DOF interaction, and will also be extended to an admittance-type haptic interaction. The approach according to the present disclosure may also be implemented with regard to a teleoperation system.

The implementations of the functional operations and subject matter described in the present disclosure may be realized by a digital electronic circuit, by the structure described in the present disclosure, and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of materials influencing a machine-readable radio wave signal, or a combination of one or more thereof.

In the specification, the term “system” or “device”, for example, covers a programmable processor, a computer, or all kinds of mechanisms, devices, and machines for data processing, including a multiprocessor and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

The implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations to the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, in the specification, the operations are illustrated in a specific sequence in the drawings, but it should be understood that the operations are not necessarily performed in the shown specific sequence or that all shown operations are necessarily performed in order to obtain a preferable result. In a specific case, multitasking and parallel processing may be preferable.

Furthermore, it should not be understood that a separation of the various system components of the above-mentioned implementation is required in all implementations. In addition, it should be understood that the described program components and systems usually may be integrated in a single software package or may be packaged in a multi-software product.

As described above, specific terms disclosed in the specification do not intend to limit the present disclosure. Therefore, while the present disclosure was described in detail with reference to the above-mentioned examples, a person skilled in the art may modify, change, and transform some parts without departing a scope of the present disclosure. The scope of the present disclosure is defined by the appended claims to be described later, rather than the detailed description. Accordingly, it will be appreciated that all modifications or variations derived from the meaning and scope of the appended claims and their equivalents are included in the range of the present disclosure.

A person skilled in the art could understand that various exemplary logical blocks, modules, circuits, and algorithm steps can be implemented as electronic hardware, computer software, or a combination of both. In order to clearly describe mutual compatibility between hardware and software, various exemplary elements, blocks, modules, circuits, and steps have been generally described from their functional viewpoint. Whether such a function is implemented as hardware or software depends on design restrictions imposed on the specific application and the overall system. A person skilled in the art could implement the described functions in various manners with regard to respective specific applications, but such an implementation determination is not to be interpreted as deviating from the scope of the present disclosure.

Various exemplary logical blocks, modules, and circuits described in connection with the present disclosure may be implemented or performed by a versatile processor, a digital signal processor (DSP), an application-specific integrated circuit (ASIC), a field-programmable gate array (FPGA) or other programmable logic device (PLD), a discrete gate or transistor logic, discreate hardware components, or a combination of those designed to implement the described functions. The versatile processor may be a microprocessor. Alternatively, the processor may be commercial processor, a controller, a microcontroller, or a state machine. The processor may be implemented, for example, as a DSP and a microprocessor, a plurality of microprocessors, one or more microprocessors related to a DSP core, or arbitrary different features like these.

Steps of a method or an algorithm described in relation to the present disclosure may be directly implemented by hardware, a software module executed by a processor, or a combination of both. The software module may reside in a RAM memory, a flash memory, a ROM memory, an EPROM memory, an EEPROM memory, resisters, a hard disk, a portable disk, a CD-ROM, or any other type of widely known storage medium. Such an exemplary storage medium is connected to a processor such that the processor can read information from the storage medium and can record information in the storage medium. Alternatively, the storage medium may be integrated with the processor. The processor and the storage medium may be positioned in the ASIC. The ASIC may be positioned in the user terminal. Alternatively, the processor and the storage medium may exist as separate components in the user terminal.

In one or more exemplary embodiments, the described functions may be implemented through hardware, software, or a combination of both. When implemented as software that is a computer program object, the above functions may be stored on a computer-readable medium as one or more commands or codes, or may be transmitted through the same. The computer-readable medium includes a computer storage medium and a communication medium including any medium for facilitating transfer of a computer program from one location to another location. The storage medium may be any available medium that can be accessed by a computer. For example, such a computer-readable medium may include a RAM, a ROM, an EEPROM, a CD-ROM or other optical disk storage, a magnetic disk storage or other magnetic storage devices, or any other medium which can be used to store or transfer a program code means required in a command or data structure type, and which can be accessed by a computer, but is not limited thereto. In addition, an arbitrary connecting means may be considered as a computer-readable medium. For example, when software is transmitted from a website, a server, or other remote source through a coaxial cable, an optical fiber cable, a twisted binary, a digital subscriber line (DSL), or wireless technologies such as infrared rays, radio waves, and microwaves, definition of such a medium may include the coaxial cable, the optical fiber cable, the twisted binary, the DSL, or the wireless technologies such as infrared rays, radio waves, and microwaves. The disk and disc used herein include a compact disc (CD), a laser disc, an optical disc, a DVD, a floppy disk, and a Blue-ray disc. The disk magnetically reproduces data, but the disc optically reproduces data through a laser. The above combinations should also be included in the range of computer-readable mediums.

The above-described embodiments of the present disclosure are for the purpose of illustration, and the present disclosure is not limited thereby. It could be understood by a person skilled in the art to which the present disclosure pertains that various modifications and changes are possible within the idea and scope of the present disclosure, and such modifications and changes fall within the range of the present disclosure.

The industrial applicability of the present disclosure will now be described.

According to the haptic interaction device and the method for operating the same according to an embodiment of the present disclosure, it is possible to improve the rate-hardness related to the user's recognition of a contact in a VE while providing a high stiffness, provided that stability is guaranteed in connection with a VE-based haptic interaction. As such, the same overcomes the boundary of the prior art and thus can not only be used for the relevant technology, but also have sufficient possibility of marketing or commercial use of the devices to which the same is applied. Accordingly, the present disclosure can be implemented practically and obviously, and thus has industrial applicability.

Hereinafter, claims according to an embodiment of the present disclosure will be described.

1. A haptic interaction device for improving rate-hardness, comprising:
a setting unit configured to make settings such that, when a desired stiffness related to a penetration depth of a haptic interaction point in a virtual environment and a feedback force corresponding to the penetration depth is determined, a feedback force is generated according to the desired stiffness in a pressing path of the initial cycle during which the haptic interaction point initially penetrates the virtual environment, and a feedback force is generated according to a stiffness lower than the desired stiffness in a releasing path of the initial cycle and in a pressing path and a releasing path of the following cycle;
a checkup unit configured to check, when a cycle is ended, stiffness at the cycle during which the haptic interaction point penetrates the virtual environment along a pressing path and moves along a releasing in the opposite direction to the penetration direction; and
a determination unit configured to determine a feedforward force offset value related to a feedback force at the next cycle adjacent to the cycle on the basis of a result of comparing the stiffness checked at the cycle and the desired stiffness.

2. The haptic interaction device of claim 1, wherein the feedforward force offset value is determined such that, when the stiffness checked at the cycle is smaller than the desired stiffness by at least a threshold value, the offset value at the adjacent next cycle is determined to larger than the offset value at the cycle,
when the stiffness checked at the cycle is larger than the desired stiffness by at least the threshold value, the offset value at the adjacent next cycle is determined to smaller than the offset value at the cycle, and
when the difference between the stiffness checked at the cycle and the desired stiffness is within the threshold value, the feedforward force offset value is determined to toggle with reference to the offset value at the cycle.

3. The haptic interaction device of claim 1, wherein, when the feedback force at the initial cycle is set according to the desired stiffness, a rate-hardness related to recognition of a contact in the virtual environment by a user is improved compared with a rate-hardness of a case in which the feedback force is set according to a stiffness lower than the desired stiffness.

4. The haptic interaction device of claim 1, wherein the releasing path is set such that a feedback force exists even when the haptic interaction point has escaped from a virtual wall which is a boundary of the virtual environment, and the feedback force outside the virtual environment is set to be continuous on a line of extension of the feedback force inside the virtual environment.

5. A haptic interaction method for improving rate-hardness, comprising:
making settings such that, when a desired stiffness related to a penetration depth of a haptic interaction point in a virtual environment and a feedback force corresponding to the penetration depth is determined, a feedback force is generated according to the desired stiffness in a pressing path of the initial cycle during which the haptic interaction point initially penetrates the virtual environment, and a feedback force is generated according to a stiffness lower than the desired stiffness in a releasing path of the initial cycle and in a pressing path and a releasing path of the following cycle;
checking, when a cycle is ended, stiffness at the cycle during which the haptic interaction point penetrates the virtual environment along a pressing path and moves along a releasing in the opposite direction to the penetration direction; and
determining a feedforward force offset value related to a feedback force at the next cycle adjacent to the cycle on the basis of a result of comparing the stiffness checked at the cycle and the desired stiffness.

6. The haptic interaction method of claim 5, wherein the feedforward force offset value is determined such that, when the stiffness checked at the cycle is smaller than the desired stiffness by at least a threshold value, the offset value at the adjacent next cycle is determined to larger than the offset value at the cycle,
when the stiffness checked at the cycle is larger than the desired stiffness by at least the threshold value, the offset value at the adjacent next cycle is determined to smaller than the offset value at the cycle, and
when the difference between the stiffness checked at the cycle and the desired stiffness is within the threshold value, the feedforward force offset value is determined to toggle with reference to the offset value at the cycle.

7. The haptic interaction method of claim 5, wherein, when the feedback force at the initial cycle is set according to the desired stiffness, a rate-hardness related to recognition of a contact in the virtual environment by a user is improved compared with a rate-hardness of a case in which the feedback force is set according to a stiffness lower than the desired stiffness.

8. The haptic interaction method of claim 5, wherein the releasing path is set such that a feedback force exists even when the haptic interaction point has escaped from a virtual wall which is a boundary of the virtual environment, and the feedback force outside the virtual environment is set to be continuous on a line of extension of the feedback force inside the virtual environment.

9. A computer program implemented so as to execute respective steps of one of claims 5 to 8 and recorded in a computer-readable recording medium.

10. A computer-readable recording medium comprising an instruction for executing respective steps of one of claims 5 to 8.
